(19) United States
(12) Patent Application Publication
(10) Pub. No.: US 2026/0303702 A1
(43) Pub. Date: Oct. 1, 2026

(54) ENABLING EXTENDED REALITY SERVICE PROXIES

(71) Applicant: InterDigital Patent Holdings, Inc., Wilmington, DE (US)

(72) Inventors: Xavier De Foy, Kirkland (CA); Michael Starsinic, Newtown, PA (US); Magurawalage Chathura Madhusanka Sarathchandra, London (GB); Jaya Rao, Montreal (CA); Rocco Di Girolamo, Laval (CA); Michelle Perras, Montreal (CA); Achref Methenni, Montreal (CA); Renan Krishna, Brighton (GB)

(73) Assignee: InterDigital Patent Holdings, Inc., Wilmington, DE (US)

(21) Appl. No.: 19/704,172

(22) Filed: Jun. 10, 2026

Related U.S. Application Data
(63) Continuation of application No. 18/863,126, filed on May 5, 2023, now abandoned.
(60) Provisional application No. 63/338,727, filed on May 5, 2022.
(60) Provisional application No. 63/414,241, filed on Oct. 7, 2022.

(51) Int. Cl. H04L 67/562; H04L 65/1069

(52) U.S. Cl. CPC H04L 67/562; H04L 65/1069

(57) ABSTRACT

Systems, methods, and instrumentalities are disclosed herein for enabling extended reality (XR) service proxies. A first network node may receive a session request from a WTRU for a data session and MOQ service. The first network node may determine a MOQ proxy deployment, including a local and network proxy. Based on the network proxy deployment, the first network node may determine a second network node to provide the MOQ service and network MOQ proxy. The first node may send a proxy establishment message to request the network MOQ proxy and a session establishment message to request a local MOQ proxy from the WTRU.

### CROSS-REFERENCE TO RELATED APPLICATIONS

This application is a continuation of U.S. patent application Ser. No. 18/863,126, filed Nov. 5, 2024, which is the National Stage Entry under 35 U.S.C. § 371 of Patent Cooperation Treaty Application No. PCT/US2023/021183, filed May 5, 2023, which claims the benefit of U.S. Provisional Application No. 63/338,727, filed May 5, 2022 and U.S. Provisional Application No. 63/414,241 filed Oct. 7, 2022; the contents of which are hereby incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed herein for enabling extended reality (XR) service proxies. A first network node may receive a session request message from a wireless transmit/receive unit (WTRU), and the session request message may request a data session and request a media over QUIC (MOQ) service. The first network node may determine a MOQ proxy deployment for the MOQ service, and the MOQ proxy deployment may include a local proxy deployment and a network proxy deployment.

The first network node may determine, based on the network proxy deployment, a second network node to provide the MOQ service and to provide a network MOQ proxy. The first network node may send a proxy establishment message to the second network node, and the proxy establishment message may request that the second node provide the network MOQ proxy for the MOQ service. The network MOQ proxy may support the data session.

The first network node may send a session establishment message to the WTRU based on the local proxy deployment, and the session establishment message may request that the WTRU provide a local MOQ proxy that supports the data session to communicate with the network MOQ proxy.

The first network node may receive policy information from a third network node, and the policy information may include at least one of Policy and Charging Control (PCC) rules or session rules. The first network node may determine the MOQ proxy deployment using at least one of the PCC rules or the session rules.

The first network node may determine a capability of the second network node to support a MOQ proxy functionality. The first network node may select the second network node based on the capability of the second network node.

The first network node may determine a capability of the second network node to support a MOQ extension, and the MOQ extension may include an extended reality (XR) service extension. The first network node may select the second network node based on the capability of the second network node.

The proxy establishment message may be sent to the second network node using an N4 interface, and the proxy establishment message may include at least one of a MOQ service flag or a MOQ proxy configuration information element.

The first network node may receive a session establishment response message from the second network node, and the session establishment response message may include MOQ proxy information. The MOQ proxy information may include one or more of a MOQ proxy IP address, a domain name, or a port.

The first network node may send the session establishment message to the WTRU, and the session establishment message may include the MOQ proxy information received in the session establishment response message from the second network node.

The first network node may receive network MOQ proxy information from the second network node in response to the proxy establishment message. It may be possible to determine a network MOQ proxy discovery method based on the network MOQ proxy information, and the network MOQ proxy discovery method may assist the WTRU to discover the network MOQ proxy. The first network node may determine the capability of the second network node for providing the network MOQ proxy based further on any of a local configuration or a management plane message. The session establishment message may include a MOQ proxy information element.

The first network node may include a MOQ proxy information element in the session establishment message sent to the WTRU. This may be done, so that the first network node may be a proxy for the WTRU.

A procedure that may be used to establish XR flow connectivity and enable XR services on these flows. XR flows may be transported between wireless transmit/receive unit (WTRU), user plane function (UPF), and/or application server (AS) over a proxied connection. XR service information elements (IEs) may be associated with XR flows, protocol data unit (PDU) sets, and packets to enable XR services to be provided, using these IEs, by WTRU/UPF/AS and intermediate radio access network (RAN) and/or core network (CN) nodes.

A procedure to establish Media-over-QUIC (MOQ) connectivity through Secure MOQ Relays, which may enable a network to provide XR support services, may be provided. Embodiments herein may incorporate and/or provide a technique enabling mapping PDU set descriptor messages to PDUs sent over MOQ through Secure MOQ Relays, and/or a technique to discover and establish communication through the MOQ relay(s) deployed in a network and/or on a WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIGS. 2A-2D show example data plane architectures that may be used for extended reality (XR) services, such as for XR services and/or for data packets.

FIGS. 3A-3E show example establishment and operation procedures of XR services which may be how XR services are established and operated.

FIG. 4 shows an example protocol data unit (PDU) set selection.

FIGS. 5A and 5B show an example procedure of a MASQUE-based PDU set, based QoS handling. It may be possible to handle QoS using this method.

FIG. 6 shows an example of a secure MOQ Relay Model.

FIG. 7 shows an example of a deployment scenario for Secure MOQ Relays.

FIGS. 8A-8C may show an example XR Service Operation through a secure MOQ relay.

FIG. 9 shows an example representation of a capsule message to/from a secure MOQ relay.

FIGS. 10A and 10B show an example representation of a PDU sent over MOQ using a secure MOQ relay in mode 1.

FIG. 11 shows an example representation of a PDU sent over a MOQ using a secure MOQ relay in mode 2.

FIG. 12 shows an example MOQ relay discovery and connection establishment procedure.

### DETAILED DESCRIPTION

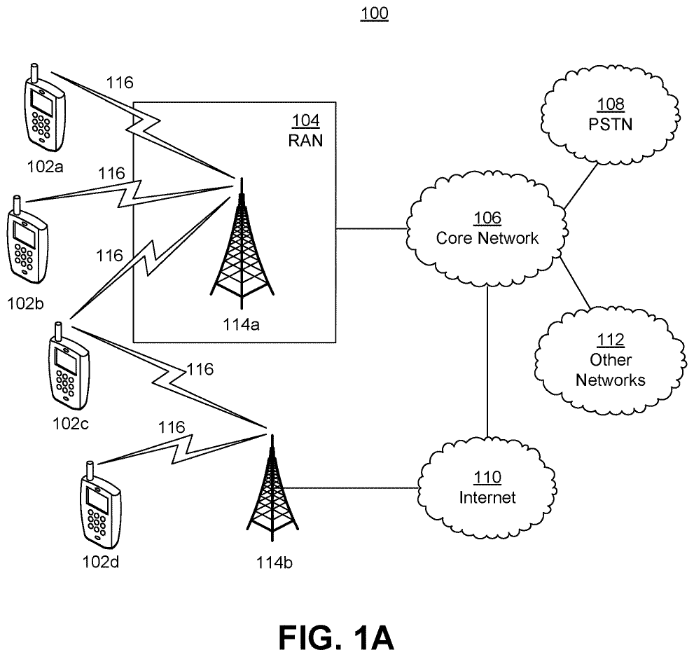

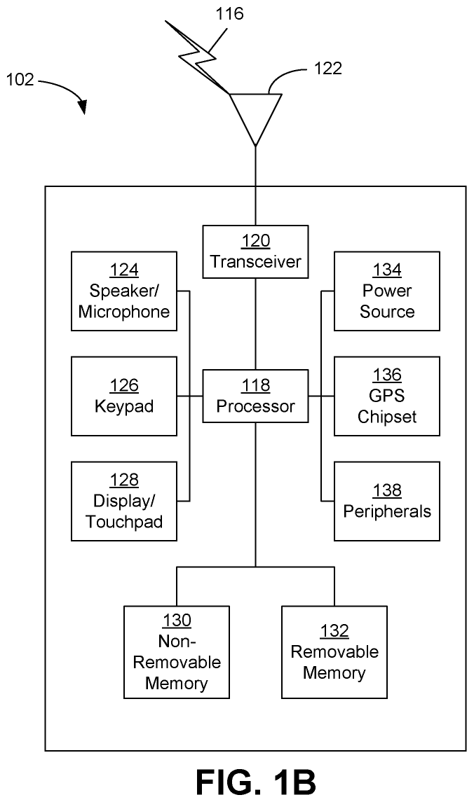

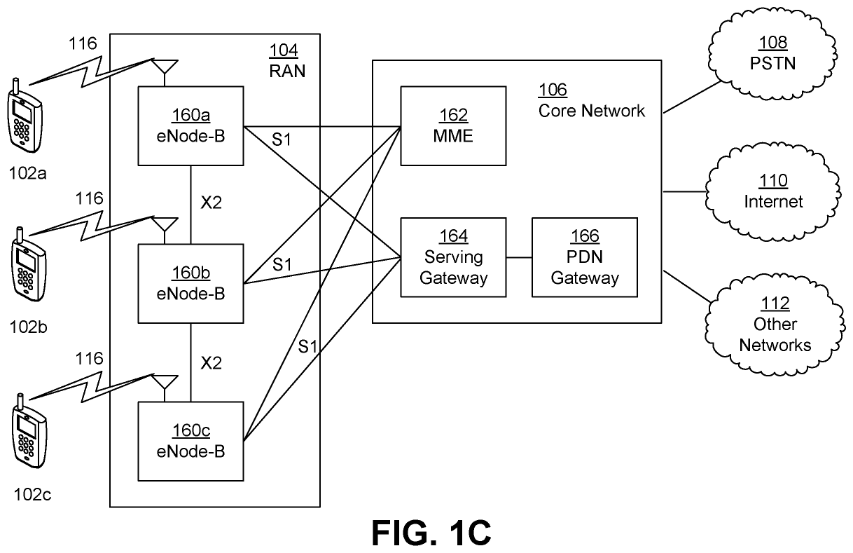

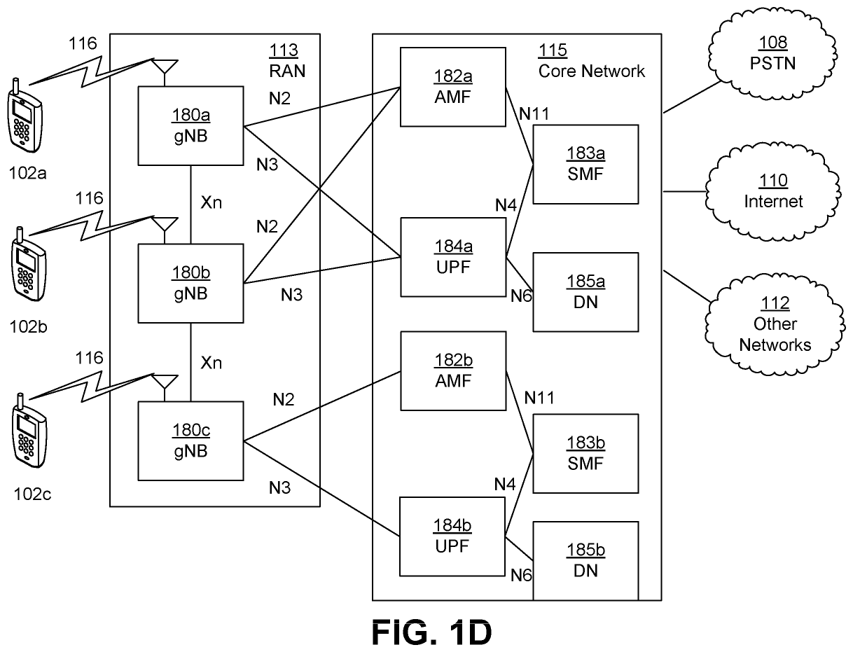

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to a time, a time period, tracking the time, tracking the period of time, etc. Reference to a timer expiration herein may refer to determining that the time has occurred or that the period of time has expired.

Extended reality (XR) applications, protocol data unit (PDU) sets, and/or multi-modal synchronization may be provided.

For XR applications on mobile networks, enhancements may be used to support advanced media services (e.g., high data rate, low latency services such as augmented reality (AR), virtual reality (VR), and/or XR services). These services may be designated as XR services and may be described as such herein. Enhancements may include one or more of the following: support for multi-modal data streams (e.g., related audio, video, and haptic data); interaction between the system and application for synchronization and QoS; QoS support for media unit granularity; uplink-downlink transmission coordination to meet round trip time (RTT) latency; jitter minimization; or power saving enhancements. In examples, a WTRU involved in an XR application session may access the mobile network through a relay WTRU, e.g., over a device-to-device (D2D) link. For example, tethering may include an AR/VR glass WTRU to a phone.

A PDU set may be defined to improve QoS handling of XR traffic. A PDU set may include one or more PDUs carrying the payload of one unit of information generated at the application level (e.g., a frame and/or video slice for extended reality and media (XRM) services). The PDUs, including a PDU set, may be equally important (e.g., all equally important) at an application layer. In examples, the PDUs (e.g., all PDUs) in a PDU set may be used by the application layer to use the corresponding unit of information. In examples, the application layer may recover parts of the information unit, e.g., if multiple PDUs of a PDU set are missing.

Quick UDP Internet Connections (QUIC) and Multiplexed Application Substrate over QUIC Encryption (MASQUE) may be provided. The MASQUE protocol may enable configuring and/or running multiple proxied flows in a hypertext transfer protocol (HTTP) connection, for example, using HTTP/3 over QUIC. The MASQUE services may include user datagram protocol (UDP) proxying and internet protocol (IP) proxying. To initiate a UDP proxying service, the client may send an HTTP CONNECT request to a proxy, for example, using a uniform resource locator (URL) such as https://masque.example.org/{target_host}/{target_port}/, where masque.example.org may be a qualified domain name (e.g., a fully qualified domain name (FQDN)) resolving into a MASQUE proxy, where {target_host} may be a remote server FQDN or IP address, and where {target_port} may be the target UDP port on the remote server. The HTTP CONNECT may include a “connect-udp” service label, for example, as a protocol pseudo-header value or upgrade header value. Upon accepting such a request, a MASQUE proxy may start forwarding UDP traffic between a client and a remote server. Data traffic between the client and the MASQUE proxy may include packets containing the end-to-end UDP payload sent over datagrams associated with the stream used by the CONNECT request. Datagrams may be HTTP datagrams or datagram-type CAPSULE messages, where CAPSULE may be a TLV-based protocol defined over HTTP/3, HTTP/2, and HTTP/1.1 data streams. Between the MASQUE proxy and the remote server, data traffic may be transmitted over UDP/IP. Other services may be provided by a MASQUE proxy. For example, IP proxying may be initiated with a CONNECT request, including a connect-ip service label.

Access traffic steering, switch, and splitting (ATSSS) may be provided. WTRU may be capable of access (e.g., both 3GPP access and non-3GPP access). The capability may provide flexibility to the network operators in determining which access to use for a service data flow. ATSSS may rely on setting up a multi-access (MA) PDU session where traffic from a service data flow may be sent over access (e.g., 3GPP access, over non-3GPP access, or over both accesses). ATSSS may rely on steering functionality logic to enable the switching, steering, or splitting. Steering functionalities (e.g., two steering functionalities) may have include one or more of the following: multi-path transmission control protocol (MPTCP) (e.g., which may be used for transmission control protocol (TCP) traffic) and ATSSS-LL (e.g., which may be used for Ethernet, TCP, or UDP traffic). Steering functionalities may be used for carrying UDP, Ethernet, and other types of traffic over MA-PDU sessions. The functionalities may include a steering functionality based on the QUIC protocol, e.g., possibly including its multipath extension, and/or a steering functionality based on the DCCP protocol, e.g., possibly including its multipath extension.

Differentiated services codepoint (DSCP) may enable, using a 6-bit field in IP headers, setting a traffic handling policy in an IP network. DSCP codepoints may be associated with per-hop behavior (PHB) in intermediate nodes (e.g., routers). One or more DSCP codepoints may be standardized, including support for best effort traffic, for the assured forwarding PHB and for higher priority expedited forwarding traffic. In an example, one-fourth of the DSCP codepoint space may be reserved to be used for experimental or local use.

XR service may be supported in mobile networks. How to identify and provide differentiated handling to packets of a PDU set may be provided. For example, how the network identifies packets as part of a PDU set, how the network determines the importance of a PDU set or its dependency on other PDU sets, how/where to perform differentiated PDU set packet handling (e.g., in WTRU, radio access network (RAN), and/or user plane function (UPF)), what information may be provided to WTRU, RAN, and/or UPF to perform this task, and/or how to provide the information may be provided.

Features may be described for XR service support in mobile networks, including performing traffic analysis/deep packet inspection (DPI) (e.g., of real-time transport protocol (RTP) header fields) by UPF and gNodeB to classify data packets into PDU sets and where PDU set information elements (IEs) may be transported in the N3 encapsulation header (e.g., GTP header). PDU set classification may be performed by the application server (AS), and PDU set IEs may be provided by the AS to the UPF using a preconfigured AS-UPF tunnel. One or more of the following may apply based on the features described herein. For PDU set classification, PDU set classification may be performed in the gNodeB and UPF, and it may rely on DPI. Using DPI may be useful to support protocols such as RTP or secure RTP (SRTP) without requesting (e.g., without requiring) the application layer to be adapted for use over a system (e.g., a 5G system), which may assist in initial adoption. Usage of DPI on gNodeB and UPF may lead to one or more of the following. DPI may not be usable on the gNodeB in cases (e.g., all cases), especially when traffic may be encrypted (e.g., RTP over datagram transport layer security (DTLS), RTP over QUIC, or non-RTP protocols such as the Warp protocol or the reliable (unreliable) streaming protocol (RUSH) over QUIC). DPI implementations may be costly to maintain to keep up with the evolution of XR protocols.

One or more of the following may apply based on the features described herein. In examples, integration may not be used between ATSS. This lack of integration may prevent, or make it more complex, using XR service IEs to make path selection or packet scheduling decisions. For example, in some settings, using one path, e.g., with low packet loss, may be useful for I-frames, while other paths may be used for less important PDU sets. The system (e.g., 5G system) may provide a feature that interworks with the ATSSS feature, including when higher layer ATSSS (e.g., based on QUIC/DCCP) may be used.

Based on the features described herein, one or more of the following may apply. For preconfigured N6 tunnels, a set of preconfigured N6 tunnels between the UPF and a trusted 5G-XR Application Server (5G-XR AS) may be used and carry one or more IEs related to PDU sets. This may include limitations, such as not supporting an untrusted AS and/or using a pre-configuration of a generic routing encapsulation (GRE) or GTP tunnel. The system (e.g., 5G system) may provide a feature that enables dynamically setting up a proxied connection to an application server trusted or untrusted by the operator (e.g., 5G operator).

Based on the features described herein, one or more of the following may apply for the identification of PDU sets, and features described herein may enable PDU set marking on a per-packet basis. The overhead may ensure that the network nodes (e.g., all network nodes) providing XR services have the information (e.g., all the necessary information) to be aware of the number of packets, priority level, and dependency between PDU sets. The system (e.g., 5G system) may enable PDU set marking while limiting per-packet overhead.

Features described herein may or may not enable the network to influence network nodes providing XR service when congestion may be detected. For example, the system (e.g., 5GS) may use L4S/ECN to influence applications that support this protocol and to influence the XR service, even when the application may not support L4S/ECN. The system (e.g., 5G system) may support L4S/ECN marking by the network, L4S/ECN influenced congestion control in the XR service, and relay, by the XR service, of L4S/ECN signaling to supporting XR application.

Proxied connections may be established for the features described herein, e.g., between the WTRU and UPF, to carry XR flows. In examples, a chain of proxied connections may be established, e.g., between WTRU, relay WTRU, I-UPF, and/or PSA UPF. Procedures may be described to establish such a proxied connection, while associating XR service IEs with XR flows, with PDU sets, and/or with individual packets.

Using the associated XR service IEs, nodes (e.g., WTRU, UPF, relay WTRU, I-UPF, PSA UPF, gNodeB, gateways, and other RAN/CN nodes) may implement XR services. XR services may include PDU set classification and marking, relay of XR service marking, support functions for XR path selection, XR packet scheduling, XR congestion handling, and/or support functions for XR synchronization.

XR proxies may be collocated with UPF and/or other nodes (e.g., WTRU, UPF, relay UE, I-UPF, PSA UPF, gNodeB, gateways, and other RAN/CN nodes). An XR proxy may be referred to herein as a proxy. In examples where a proxy may be collocated with UPF, an XR proxy may be referred to herein as UPF/proxy or UPF.

An XR proxy collocated with a function (e.g., such as a UPF) may be instantiated on the same node as the function, e.g., sharing computing resources with a UPF function, or may be instantiated on a node connected to the function, e.g., on a virtual network function (VNF) deployed in a same data center as a UPF function. A proxy may be described as being on a UPF to indicate a form of collocation (e.g., any form of collocation).

One or more of the following may apply based on the features described herein. Uplink PDU sets may be marked by the WTRU (e.g., not the gNodeB), which may enable supporting encrypted XR flows and may enable using an access network (AN) (e.g., non-3GPP access network)). Downlink PDU sets may be marked by AS (e.g., non-legacy AS) instead of UPF, which may enable supporting encrypted XR flows. A DPI may be supported when it brings value (e.g., to support legacy AS). A UPF proxy (e.g., QUIC-based or DCCP-based) may be used to provide ATSSS service and XR service, which may enable combining ATSSS IEs and XR service IEs in path selection and packet scheduling. Combining ATSSS and XR services may reduce, e.g., through code reuse, the cost of implementing the XR proxy-based mechanism, as described herein. In a MASQUE-based proxy feature, such as described herein, the UPF/proxy may authenticate an AS (e.g., non-legacy AS) prior to sending a MASQUE CONNECT request to it, which may establish (e.g., dynamically establishes) a proxied connection/tunnel to the AS. Web-based authentication techniques may be used as a building block to establish trust between a WTRU application, operator (e.g., 5G operator), and/or AS operator, depending on the trust model. Tunnel establishment may be dynamic. XR service IEs described herein may be associated per flow, per PDU set, and/or per packet. It may be possible to reduce the set of per-packet XR service IEs to the minimum set used by intermediate nodes to apply XR services. Other XR service IEs may be exchanged over the proxied connection, e.g., between WTRU and UPF, at a lower rate and may enable XR services by WTRU/UPF/AS. This may reduce and/or minimize the per-packet overhead from XR service IEs. Congestion markings (e.g., ECN or L4S) may be set by intermediate RAN/CN nodes on the outer header of packets sent between WTRU and UPF. The markings may be used by WTRU/UPF to apply XR services and/or may be relayed to the application.

A data plane architecture overview may be provided.

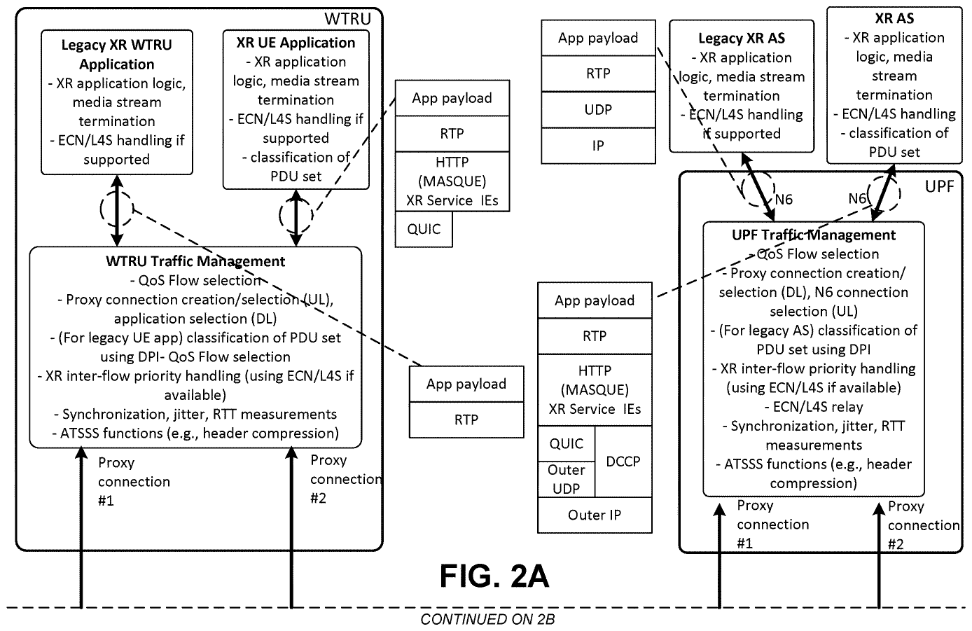

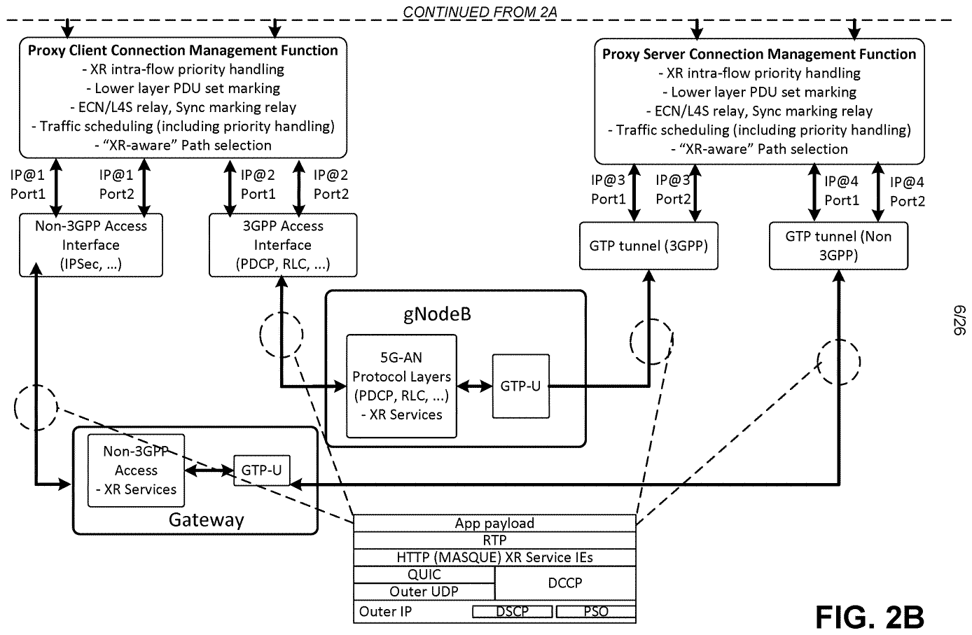

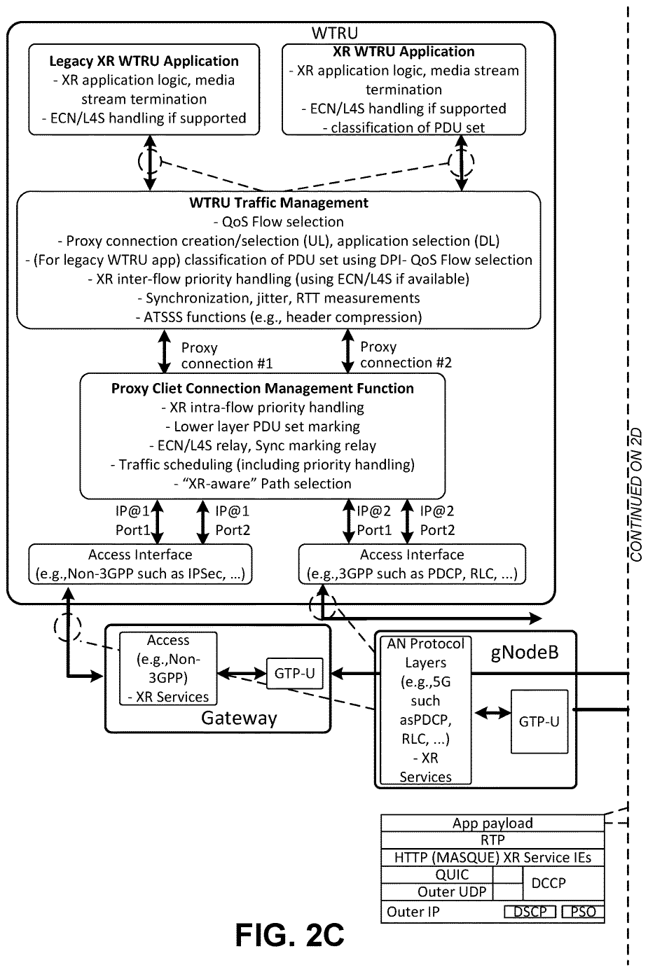

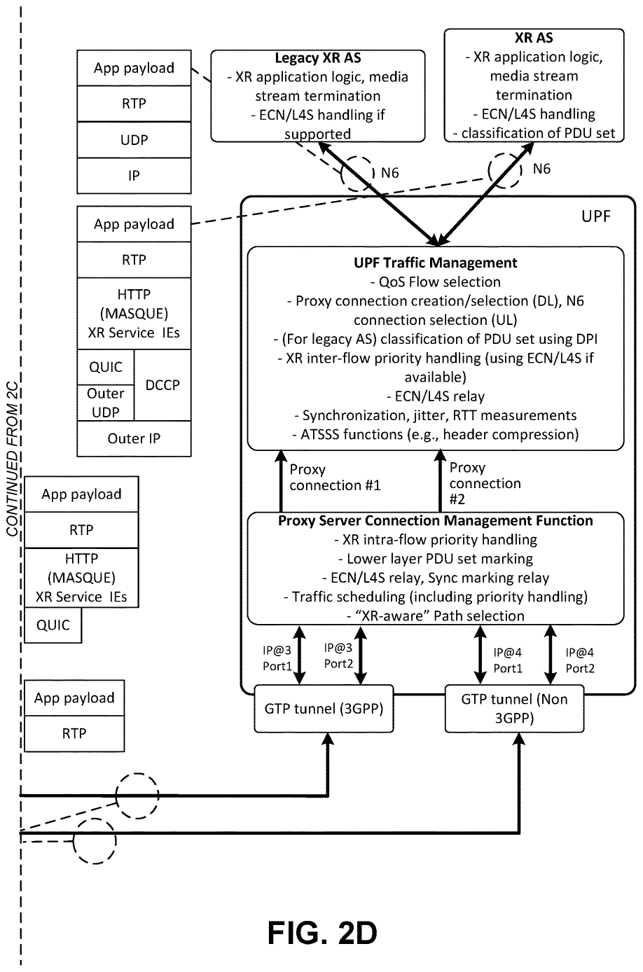

FIGS. 2A-2D show an example of a data plane architecture for XR services, including XR services and data packets.

An XR application session may be established between an XR WTRU application (WTRU app) and an XR AS located in a data network (DN). An XR WTRU app/AS may implement XR application logic and send/receive media streams. An XR WTRU app/AS may handle congestion feedback from the network (e.g., ECN or L4S). An XR WTRU app/AS may support XR services described herein, such as classification and marking of PDU sets. An XR WTRU app/AS that does not support XR services (e.g., any XR services) described herein may be referred to as a legacy XR WTRU app/AS.

A number of functions may be provided. For example, the functions, as shown in FIGS. 2A-2D, may include an AS hosting an XR application and a WTRU hosting an XR WTRU application. XR WTRU app and XR AS may be involved in (e.g., send and receive XR flows as part of) an application session. While in this setting there may be a single WTRU and AS, other settings may have multiple WTRUs and/or ASs involved in an application session. XR services described herein may apply to multiple XR flows to/from multiple WTRUs (e.g., multi-modal multi-device synchronization). Non-legacy WTRU app and AS may provide XR services as described herein.

XR flows may be video/audio/haptic/object service data flows that include an XR application session and are subject to XR services by the mobile network. XR flows may be transmitted over single-access and/or multi-access PDU sessions between WTRU and UPF and over the N6 interface between UPF and AS. In other settings (e.g., not shown in FIGS. 2A-2D), XR flows may be transmitted over device-to-device links (e.g., over PC5 reference point) between a WTRU (e.g., AR glasses) and a relay WTRU. A SMF may be used to handle signaling (e.g., all signaling) of a given XR application session. In example, a single UPF may be involved in handling XR flows (e.g., all XR flows) of a given XR application session. In examples, e.g., involving multiple distributed WTRUs/AS, multiple UPFs may be involved and may use coordination. For example, XR flow synchronization involving multiple UPFs may use one UPF to be designated as a synchronization server and exchange timing information with other UPFs to enable XR synchronization service.

In this architecture, a proxy, e.g., in UPF and relay UE, may be used to tunnel XR flows over a proxied connection. A proxy may be in a UPF or relay WTRU. The proxy may be used to enable XR services. XR flows may be carried over a proxied connection (e.g., between WTRU and UPF) or a chain of proxied connection (e.g., between WTRU, relay WTRU and UPF such as between WTRU app, WTRU and UPF). In examples, a proxied connection mechanism may be a MASQUE-based tunnel over HTTP/3 over QUIC. In examples, a proxied connection may use a tunnel over HTTP over DCCP. Other proxy connection mechanisms may be used to implement the procedures described herein.

Proxy client and proxy server connection management functions may handle single or multi-path connections and may be present in WTRU, UPF, and intermediary nodes such as relay WTRU, and/or I-UPF. Other UPF/WTRU functions may be grouped in a traffic management function that directs traffic to and from lower-layer functions, such as the client/server proxy connection management functions. XR services may be performed in traffic management functions, and/or may be performed in proxy connection management functions.

XR services may be provided by RAN and core network (CN) functions, including WTRU, UPF, gNodeB, and gateways, to support the QoE of the XR application session. In examples, XR services may be described in WTRU/UPF of FIGS. 2A-2D. One or more XR services may be allocated to traffic management functions and proxy connection management functions. For example, XR services applicable to multiple flows concurrently (e.g., interflow synchronization support) may be performed in the traffic management function, while other XR services, such as PDU set marking or intra-flow synchronization support may be performed in the proxy connection management function. XR services may be implemented by different nodes/functions.

As shown in FIGS. 2A-2D, XR flow packets may be provided. While RTP packets are represented, XR flow may use other protocols, such as DASH, RUSH, WARP, RTP over DTLS, RTP over QUIC, SRTP, etc. Legacy AS and WTRU app may exchange RTP packets directly with WTRU/UPF, while non-legacy AS and WTRU app may use another means to convey PDU set marking, such as using MASQUE encapsulation. XR flow packets between WTRU and UPF may use MASQUE encapsulation (e.g., the RTP data packet may be encapsulated in an HTTP/3 datagram associated with XR service IEs per-PDU set XR service IEs) in a PDU set descriptor. Per-flow XR service, IEs may be communicated, e.g., between WTRU and UPF, when setting up a flow. To enable the application of XR services by intermediary RAN/CN nodes, one or more XR service IEs (e.g., per-packet XR service IEs) may be placed in the outer IP header, e.g., using DSCP and/or a PDU set IP option (e.g., PSO).

In the case where XR traffic may be encrypted by the application, the non-legacy WTRU application and AS may perform XR services such as PDU set classification and provide per-XR flow IEs and per-PDU set IEs to WTRU/UPF, e.g., using MASQUE as described herein. WTRU/UPF may use the XR service IEs provided by WTRU app/AS to provide other XR services, including per-packet XR service IE marking. Other RAN/CN functions may provide XR services using per-packet XR service IEs (e.g., DSCP and IP header option) or by being collocated with a function providing an XR proxy (e.g., gNodeB collocated with I-UPF).

XR service may be provided. An XR Service may be used herein to designate services provided by, for example, a mobile network to support QoE for XR and other applications. XR services provided by WTRU/UPF/SMF/AS may include PDU set classification and marking, support functions for XR path selection, XR packet scheduling, XR congestion handling, and/or XR synchronization.

PDU set classification and marking may be provided. WTRU/UPF/AS may determine the application data content and/or boundaries that belong to a distinct PDU set, which may be associated with a PDU set priority. PDU set classification may be based on application logic (e.g., AS and WTRU app may associate each I-frame, P-frame, and B-frame with distinct PDU sets, and/or the AS and WTRU app may associate a slice of a video frame with a distinct PDU set). It may be possible to support legacy applications that do not support PDU set classification. The WTRU/UPF may perform DPI to determine the boundaries of PDU sets, e.g., using RTP header fields or other IEs present in packets. Once classification may be performed, WTRU/UPF/AS may perform per-PDU set marking of PDU set IEs as described herein. WTRU/UPF/AS may mark individual packets with per-packet XR service IEs, as described herein, to enable the network to provide XR services.

The relay of XR service marking between the application and network may be performed. For example, an AS (e.g., respective WTRU application) may perform per-PDU set marking, and UPF (e.g., respective WTRU) may mark individual packets with per-packet XR service IEs based on per-PDU set marking.

Support functions for XR path selection, XR packet scheduling, and XR congestion handling may include actions such as reordering packets, dropping packets, marking packets for congestion (e.g., L4S or ECN), and/or determining whether to send a packet over one or multiple paths. Congestion marking of packets may be performed when a forwarding queue buffer usage reaches a threshold (e.g., L4S marking) or when experiencing or anticipating congestion (e.g., ECN marking). The selection of packets for congestion marking, dropping, and/or reordering may be determined using XR service IEs, including XR flow ID, XR flow priority, XR application session ID, XR application session priority, PDU set sequence number, PDU set priority, and/or parent PDU set sequence number. This operation may be based on other IEs, such as the loss of a packet in a PDU set (e.g., an incomplete PDU set) or its parent PDU set. A WTRU/UPF/AS may request a remote peer to stop sending a PDU set (e.g., if it becomes unusable by the application because its parent PDU set was incompletely received or may be otherwise unusable). A parent PDU set may be a PDU set that may be used to be received by the application. For a PDU set (e.g., a child PDU set) to be usable by the application to enable this, a WTRU/UPF/AS (e.g., any WTRU/UPF/AS) may send a CLOSE_PDU_SET(ID) message, as described herein, where the ID (e.g., a context ID) may identify the PDU set to stop sending. The remote peer may stop sending packets of this PDU set based on the reception. In examples of integration with ATSSS, a WTRU/UPF may select the path(s) to use for sending a packet based on XR service IEs. ATSSS steering modes may be described using XR service IEs to determine path selection (e.g., send packets from PDU sets of a specified priority on a path with the lowest packet loss ratio).

Support functions for XR synchronization may include, for example, one or more of the following: supporting intermodal QoE (e.g., adapt the QoS of flows and if necessary, apply a local delay on some packets to reduce and/or minimize inter-modal delay and to minimize jitter); measuring RTT and jitter to report to application; or obtaining latency measurement using XR service IE and/or transport protocol latency estimation and providing latency measurements to SMF which updates QoS of UL and DL flows to meet round-trip latency (e.g., round-trip latency requirements).

XR Services may be provided on RAN/CN nodes. Support functions for XR path selection, XR packet scheduling, XR congestion handling, and/or XR synchronization described herein may be performed in the WTRU and/or RAN/CN nodes such as gNodeB and I-UPF. The RAN/CN nodes may use per-packet XR service IEs, e.g., in IP header, to identify packets related to PDU sets and apply related XR services. A WTRU or RAN node may use XR service IEs to make transmission decisions. For example, if a WTRU or RAN node determines that transmission of data from a first PDU has failed (e.g., a HARQ feedback indicates that transmission was not successful), the WTRU or RAN node may determine not to attempt retransmitting the failed first PDU and/or transmitting other PDUs that are associated with the same PDU set or other PDU sets that the XR service IEs indicate are correlated or associated with the first PDU. The decision to not attempt retransmission of failed PDUs and/or transmission of associated PDUs may be made by the WTRU or RAN node based on XR service IEs associated with per-PDU set (e.g., PDU set type and/or PDU set priority). In examples, a WTRU may determine the forwarding configuration to apply at the access stratum layers (e.g., radio bearer configuration) when transmitting in UL the one or more PDUs that the XR service IE indicates are correlated or associated with a PDU set. If the WTRU applies a forwarding configuration when transmitting a first PDU in UL, the WTRU may apply the same or similar forwarding configuration for a second PDU that the XR service IEs indicate are associated with the first PDU. In examples, the WTRU may use per-flow XR service IEs and/or per-PDU set XR service IEs to provide assistance information to the RAN node. The RAN node may use this assistance information and per-Packet XR service IEs to make scheduling decisions or to change the WTRU access stratum configuration. For example, based on per-flow XR service IEs and/or per-PDU set XR service IEs, the WTRU may determine that a particular PDU set may be no longer used (e.g., needed). The WTRU may make this decision based on timing (e.g., PDU reception may be too late to be used by application and/or jitter in PDU reception may be too high for application) or based on failing to receive an associated PDU set, such as a parent PDU set. The WTRU may provide the RAN node an indication of the PDU set that may be no longer used (e.g., needed). The WTRU may provide this indication through an RRC message, a MAC control element, or through uplink control information (UCI).

XR services on WTRU/UPF/AS may be performed by different WTRU/UPF/AS components. For example, AS (e.g., respective WTRU application) may perform PDU set classification and marking, while UPF (e.g., respective WTRU) may perform relay of XR service marking. In examples, UPF/WTRU may perform both XR services.

XR service IEs may be provided. XR service IEs may be IEs that enable, from the system (e.g., 5G system), XR services as described herein. These IEs may be associated with flows, PDU sets and/or packets.

Per-flow XR service IEs may apply to an XR flow and enable XR service functions described herein. Per-flow XR service IEs may be provided, e.g., by the WTRU, when establishing a proxied session for a given XR flow. For example, this may be a CONNECT (e.g., extended HTTP CONNECT) message sent to establish a MASQUE session or an initialization message sent over a created proxied data stream. Per-flow XR service IEs may be encoded as HTTP headers when provided in a CONNECT request. Per-flow XR service IEs may include one or more of the following: XR application session ID, which identifies the session to provide a scope for prioritizing, scheduling, and synchronizing flows, packets and PDU sets; XR application session priority, which provides a priority for inter-session prioritization to prioritize between flows belonging to different application sessions which have a same flow priority; XR flow ID, which identifies the flow for applying XR service on the flow (e.g., this ID may be provided by the mobile network and/or it may be a PDU session ID); XR flow priority, which provide a priority for inter-flow prioritization; data type (e.g., audio, video, haptic, data), which may be used for inter-flow synchronization to determine the acceptable synchronization delay between flows; XR synchronization group ID, which indicates which flows of the application session may be synchronized with each other; list of applicable XR services, which indicates which XR services (e.g., including XR services described herein) may be applied on the XR flow; or PDU set sequence numbering space declaration, which defines numbering spaces that may be used, e.g., by a WTRU/UPF, to generate PDU set sequence number from, and associates per-PDU set IEs with numbering spaces (e.g., each numbering space). For example, this may be used to associate PDU set priority and/or data type with numbering spaces. An example of HTTP header encoding is provided herein: pdu-sets: «range=“1-10000”; prio=5; type=“audio”, range=“10001-20000”; prio=6; type=“haptic”, range=“20001-30000”; prio=7; type=“video”»

Per-PDU set XR service IEs may apply to a PDU set (e.g., a specific PDU set) and may enable XR service functions described herein. Per-PDU set XR service IEs may be provided, e.g., by a WTRU/AS/UPF along with a PDU set. For example, per-PDU set XR service IEs may be sent in a PDU set descriptor, which may be transmitted using, e.g., a PDU_SET_DESCRIPTOR message described herein sent on a stream (e.g., reliable stream), a dedicated datagram (e.g., dedicated unreliable datagram) and/or on an unreliable datagram (e.g., the first datagram) holding PDU set data. When placed in a dedicated datagram or stream, the packet holding per-PDU set XR service IEs may be sent with enhanced reliability, e.g., by marking this packet with a high priority/reliability DSCP codepoint. Receivers may associate a PDU set descriptor with a PDU set by placing an ID (e.g., context ID) in both the PDU set descriptor and PDU set, as described herein. In examples, instead of using a PDU_SET_DESCRIPTOR message, the PDU set descriptor may be included in the first PDU of a PDU set or in the first K PDUs of a PDU set. Per-PDU set XR service IEs may include one or more of the following: an IE (e.g., any IE) described herein as per-flow XR service IE may be applied per-PDU set (e.g., data type may be associated with a PDU set in cases where multiple data types are transported within a same XR flow); PDU set priority, which enables prioritizing between PDU sets within a same flow or among multiple flows (e.g., among multiple flows belonging to a same application instance); PDU set type, which enables associating a domain-specific meaning with a PDU set (e.g., I-frame, P-frame, and/or B-frame and PDU set type may be useful to provide XR services where specialized processing may be required for selected types of PDU sets); PDU forward error correction (FEC) parameters, including FEC algorithm and its parameters (e.g., which may be used by WTRU/UPF/AS to recover lost packets in a PDU set protected by FEC); PDU set sequence number, which identifies a PDU set uniquely within a PDU session, XR flow or XR application session; PDU parent set sequence number, which identifies a parent PDU set that may be requested (e.g., required) to be received by the application for the PDU set (e.g., child PDU set) to be usable by the application; PDU set length, which may be the total number of packets (e.g., or of octets) in the PDU set; or timing IEs such as media unit timestamp, presentation timestamp, sending time timestamp, accumulated transmission delay, and/or PDU synchronization ID. PDU synchronization ID may identify a group of inter-related PDUs that may be presented to the user at a similar time within the same flow (e.g., a set of frames that may be presented to the user at the same time in a multi-screen setup) or between different flows (e.g., a video PDU that may be presented to the user together with haptic PDU).

Per-packet XR service IEs may apply to a specific packet and enable XR service functions described herein. Per-packet XR service IEs may be encoded in multiple ways in the outer IP (e.g., and possibly UDP using a UDP option) header. In examples, PDU set priority may be encoded using DSCP codepoints in the outer IP header, and/or per-packet XR service IEs may be encoded using an IP header extension, e.g., using a PDU set IP option as described herein. To limit per-packet overhead, per-packet XR service IEs may be as limited in size as possible while enabling XR services to be provided by the network. For example, per-packet XR service IEs may be limited to PDU set priority and PDU set sequence number LSB. Per-packet XR service IEs may include one or more of the following: an IE (e.g., any IE) described herein as per-flow/per-PDU set XR service IE may be applied per-packet; PDU set first packet flag and/or last packet flag IEs may be used to mark the first and last packet of the PDU set; PDU sequence number, which identifies a PDU (e.g., uniquely within a PDU set); or a subset (e.g., any subset) of per-flow/per-PDU set/per-packet XR service IE that may be used per-packet. For example, the n (e.g., 8) least significant bits (LSB) of the PDU sequence number and/or PDU-set sequence number may be set per-packet to limit the overhead if such subset may provide XR services by the network. In such a case, using an IE based on 8 LSB of the PDU sequence number may be sufficient if the IE rollover occurs far enough apart, which depends on the maximum PDU set rate and the design of the XR service.

Establishment and/or operation of XR services may be provided.

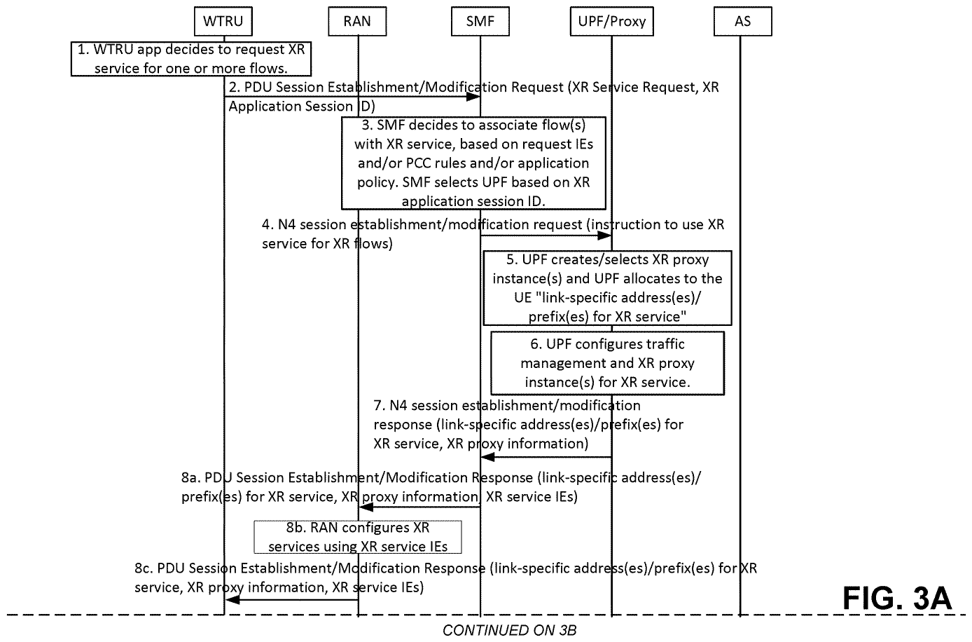

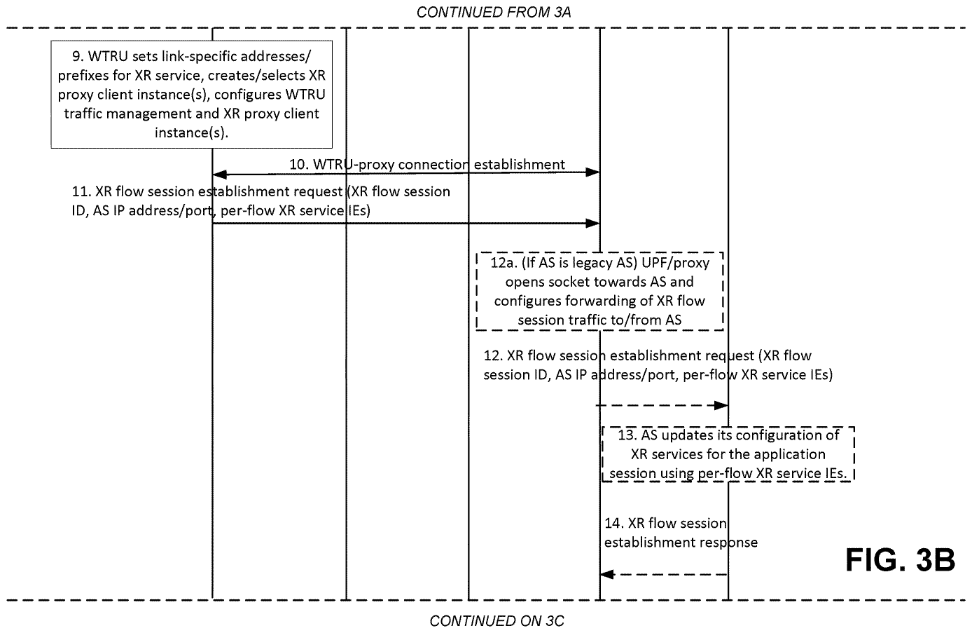

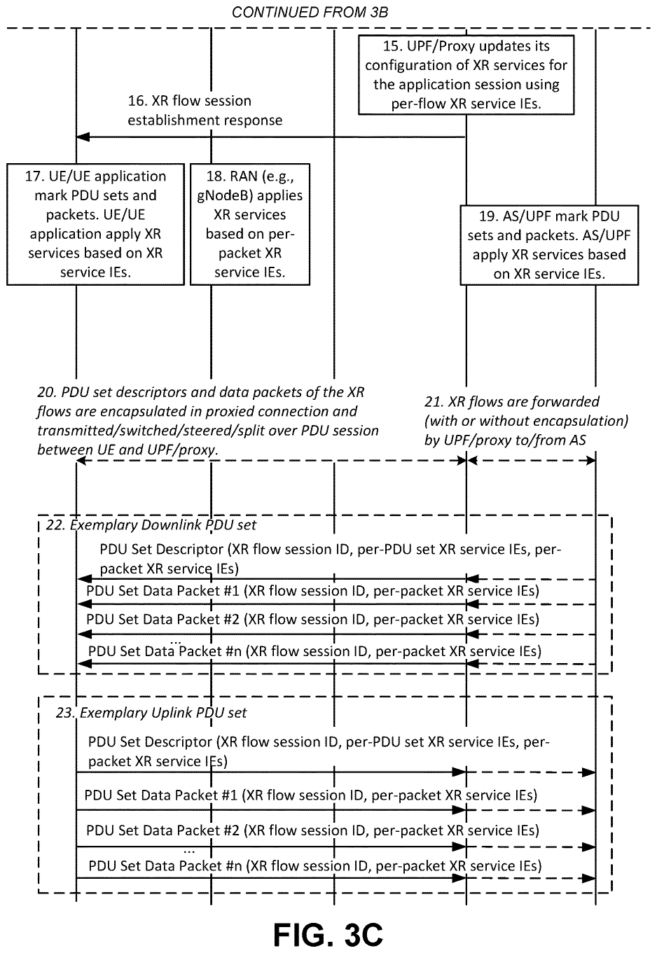

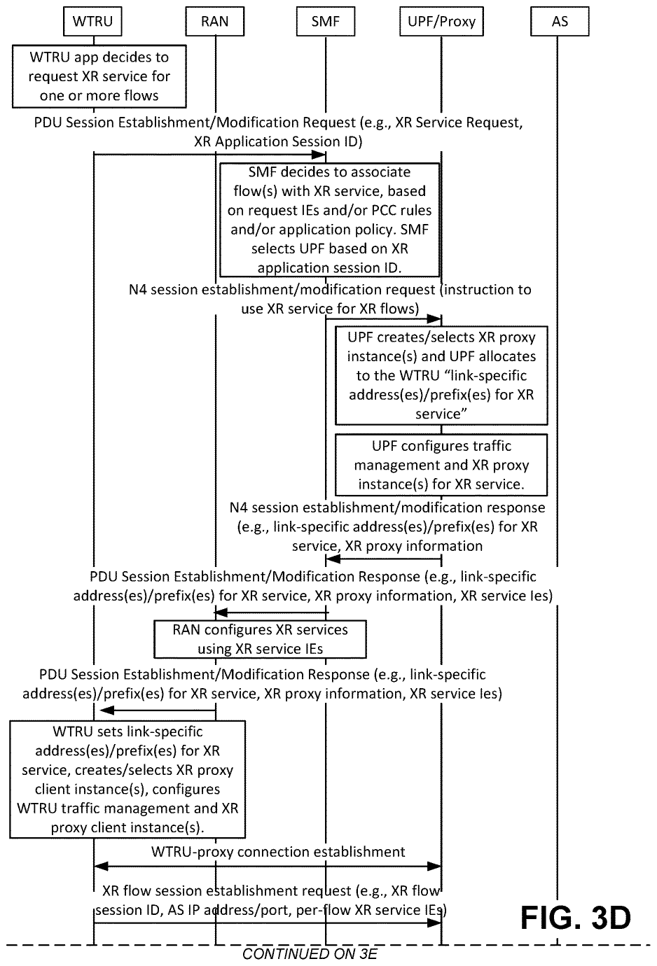

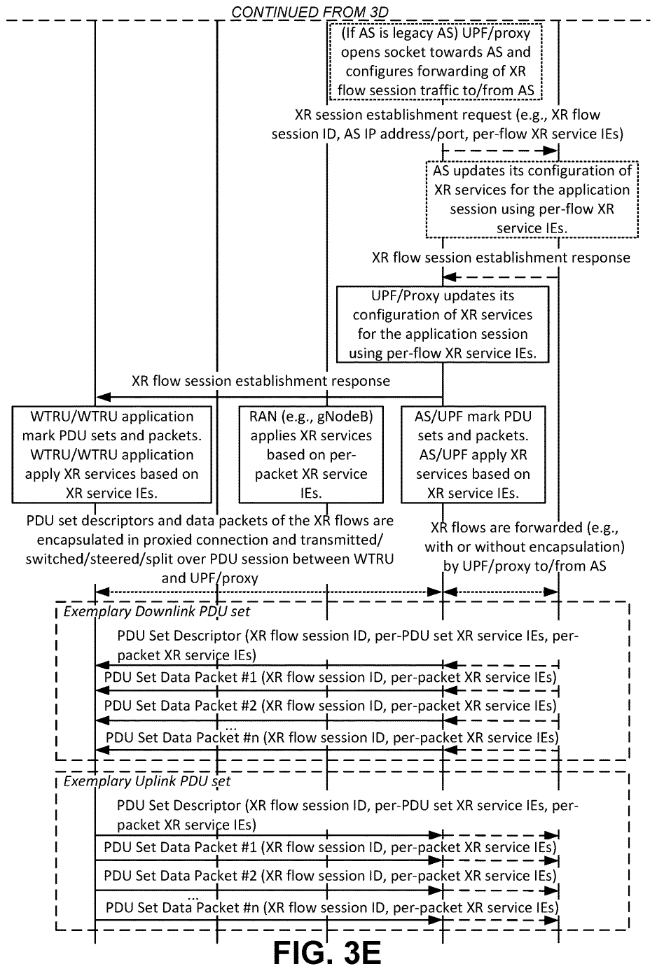

FIGS. 3A-3E show example establishment and operation procedures of XR services. As shown in FIGS. 3A-3E, a procedure for establishing and operating services on XR flows in an XR application session may be provided. This procedure may use XR service IEs and XR services described herein.

At 1, a WTRU app may decide to request XR service for one or more XR flows. For example, the WTRU app may have, e.g., prior to this point, established an application session with AS, e.g., over non-XR flows. The WTRU app may initiate communication with the AS for an XR flow (e.g., opens a socket), which triggers techniques for PDU session establishment and modification requests as described herein.

At 2, the WTRU may send to SMF, e.g., through AMF, a PDU session establishment/modification request (e.g., XR service request or a DNN/S-NSSAI combination that indicates to the network that this may be a PDU session for an XR service and/or XR application session ID). The AMF may select SMF based on XR application session ID, e.g., to ensure that a SMF (e.g., single SMF) handles the XR flows (e.g., one or more XR flows) within an application session (e.g., the same application session). XR service request IE or a DNN/S-NSSAI combination may be a flag indicating that XR service may be requested, either globally for the (e.g., or one or more eligible) flows of the PDU session or a flag may individually be present for a service data flow (e.g., a service data flow) for which XR service may be requested. If the XR service request may be a global flag, flow eligibility for XR service may be determined, e.g., by SMF, using policy charging and control (PCC) rules (e.g., for each service data flow (SDF) in a PDU session, SMF uses an XR service flag in PCC rule associated with SDF or other IEs such as protocol type, to determine if XR service may be applied to this flow). XR application session ID IE may identify an application session. The application session may provide a scope for XR services. For example, UPF may enforce priorities between XR flows within a given application session, e.g., to provide higher priority to audio flows over video flows.

At 3, the SMF may determine to associate flow(s) with XR service based on PDU session establishment/modification request IEs. It may also be based on (e.g., XR service request and/or XR application session ID), PCC rules, and/or application policy. The SMF may select UPF(s) based on XR application session ID. This may be done, for example, to ensure that a single UPF may be used, or a limited number of UPFs are used, to handle the flows of the application session.

At 4, the SMF may send to a UPF, an N4 session establishment/modification request, including an instruction to use XR service for XR flows determined herein. For example, an instruction to use XR service may be an XR control information, for example, obtained from a PCC rule. An XR control information may include one or more of the following IEs: a list of applicable XR services, including PDU set classification and marking, relay of XR service marking, support functions for XR path selection, XR packet scheduling, XR congestion handling, and/or support functions for XR synchronization; or parameters for XR services including placement of XR services (e.g., indicator whether AS or UPF perform PDU set classification and marking), XR service IEs (e.g., application session ID that XR services may apply to), and/or synchronization (e.g., synchronization requirements such as timing delay, or class of timing delay, that is acceptable between flows of different type, such as audio/video/haptic).

At 5, the UPF may create or select multiple XR proxy instances. The UPF may allocate link-specific addresses or prefixes for XR service to the WTRU. A link-specific address or prefix for XR service may be meant for the WTRU to obtain an IP address that it may use as a source address to communicate with the XR proxy.

At 6, the UPF may configure traffic management and XR proxy instance(s) for XR service. XR proxy instances may listen for incoming connection, e.g., on an IP address and UDP or DCCP port, which may be configured by UPF. An XR proxy instance may process one or more flows from one or more application sessions. In such a case, the UPF may configure one XR proxy to accept a connection from a WTRU over the PDU session and to handle the XR flows (e.g., all XR flows) of the PDU session over this connection. In cases where QUIC-based or DCCP-based ATSSS may be used, a same QUIC/DCCP proxy instance may be used for XR and ATSSS service. In such a case, the UPF may configure the proxy for joint XR and ATSSS service, which may enable path selection and packet scheduling to be performed based on XR IEs and ATSSS IEs.

In examples, in a deployment where the UPF and XR Proxy are deployed separately, the SMF may independently configure the UPF and XR Proxy. The SMF may perform configuring traffic management and XR proxy instance(s) for XR service.

At 7, the UPF may send, to SMF, a N4 session establishment/modification response (e.g., including link-specific address(es)/prefix(es) for XR service and XR proxy information). The XR proxy information may provide the IEs used (e.g., needed), by the WTRU, to connect to the XR proxy. The XR proxy information may include a proxy protocol (e.g., UDP and/or DCCP), IP address and port, and/or FQDN. XR proxy information may include IEs that are associated with this proxy, for example, a synchronization group ID (e.g., indicating that the associated proxy performs synchronization for this group), flags indicating that a specific XR service may be supported or not by the proxy, and/or other XR service IEs that may be matched by an XR flow using this proxy (e.g., application session ID). The IEs may enable the WTRU to select the applicable proxy information among multiple XR proxy information IEs provided by UPF. There may be more than one XR proxy information IEs, for example to identify multiple proxies on UPF. In examples, multiple proxies may be provided to enable the WTRU to associate flows from different XR application sessions with different proxies. In examples, multiple proxies may be provided to enable the WTRU to associate flows using (e.g., requiring) a given set of XR services with a proxy that provides this set of XR services. In examples, multiple proxies may be provided to enable the WTRU to associate flows that may be synchronized (e.g., may need to be synchronized) with each other with a proxy dedicated to their synchronization group. In such a case, a WTRU may later dynamically change the proxy used for a XR flow, for example when this XR flow becomes part of a new synchronization group. To perform this action, the WTRU may connect to a second proxy associated with the synchronization group ID and establish a second XR flow session through the second proxy, towards the AS, as described in XR flow establishment request. The WTRU may start forwarding XR flow packets over this second XR flow session and close the first XR flow session.

At 8a, the SMF may send, to the WTRU, through a RAN, a PDU session establishment/modification response. The PDU session establishment/modification response may include link-specific address(es)/prefix(es) for XR service, XR proxy information, XR service IEs, and/or the like).

At 8b, RAN nodes (e.g., gNodeB) may use the XR service IEs to configure the XR services they provide (e.g., associate PDU session and/or individual QoS flows and/or service data flows to a list of applicable XR services, synchronization group IDs, XR application session IDs, and/or other XR service IEs.

At 8c, the PDU session establishment/modification response message may include configuration information XR service IEs. This may include a list of applicable XR services, synchronization group IDs, and/or XR application session IDs.

At 9, the WTRU may locally configure link-specific addresses or prefixes for XR service. It may create, select, or manage XR proxy client instances as well as WTRU traffic management and XR proxy client instances.

At 10, the WTRU may establish a connection with UPF/proxy, where UPF/proxy designates an XR proxy on the UPF and/or another component of the UPF. The WTRU may connect to UPF/proxy. It may use the address derived from link-specific addresses/prefixes for XR service IE As the source IP address. The WTRU may connect to UPF/proxy using a destination IP address, port, and protocol obtained from XR proxy information IE. For example, the WTRU may establish an HTTP/3 connection over QUIC. It may establish this connection with the UPF/proxy.

An XR flow session may be established between the WTRU and the UPF/proxy. The XR flow session may be a tunnel that associates the XR flow data stream with per-flow, per-PDU set, and per-packet XR service IEs. an XR flow session may be, for example, a MASQUE session, which may be initiated by a client sending a MASQUE request (for example, an HTTP CONNECT request) to a proxy. The flow session may be terminated at the UPF/proxy when connecting to a legacy AS or may reach AS over a chain of proxy connection (e.g., WTRU-UPF and UPF-AS) if AS may be a non-legacy AS (e.g., that supports XR services as described herein).

At 11, the WTRU may send, to the UPF/proxy, an XR flow session establishment request (e.g., including XR flow session ID, AS IP address/port, and/or per-flow XR service IEs). For example, the message may be a MASQUE service request over HTTP (e.g., an extended HTTP CONNECT request with a connect-udp protocol field). Such a request may include the IP address and UDP port of AS to inform the UPF/proxy where to forward the traffic sent over the proxied connection. In examples, the message may be a CONNECT request with a connect-ip protocol field or a CONNECT request over DCCP, or another type of tunneling establishment request. The XR flow session ID may be an ID unique within the scope of the connection. In a MASQUE-based implementation, the HTTP/3 stream ID used for the CONNECT request may be used as an XR flow session ID. Per-flow XR service IEs described herein may be provided by the WTRU, e.g., encoded as HTTP header fields in the CONNECT request. In examples, the UPF/Proxy may send an XR flow establishment request to the WTRU to configure a flow.

At 12a, in cases where the AS may be a legacy XR AS, the UPF/proxy may open a, e.g., UDP, socket towards AS and configure itself to forward traffic between AS and the proxied connection to WTRU. The UPF/proxy may configure itself to use DPI, e.g., to perform PDU set classification. In such a case, the procedure may jump to performed UPF-proxy updates as described herein.

In cases where the AS supports XR services as described herein, UPF/proxy may perform one or more of the following. UPF/proxy may send, at 12, an XR flow session establishment request to the AS (e.g., XR flow session ID, AS IP address/port, and/or per-flow XR service IEs). This message may use the same protocol and parameters as in the XR flow establishment request as described herein (e.g., a MASQUE service request using CONNECT). A chain of proxies may be used in this manner (e.g., WTRU to relay WTRU to I-UPF to PSA-UPF to AS).

At 13, the AS may update its configuration of XR services for the application session using per-flow XR service IEs.

At 14, the AS may send an XR flow session establishment response to UPF/proxy indicating the success or failure of the operation. In examples, a feature may be set up for communicating XR services IEs association with PDUs between AS and UPF (e.g., another tunneling feature).

At 15, the UPF/proxy may update its configuration of XR services for the application session using per-flow XR service IEs. For example, the UPF/proxy may associate an XR flow (e.g., each XR flow) with corresponding per-flow XR service IEs, including an XR application session ID and a list of which XR services apply to this flow. The UPF/proxy may configure, for a proxy (e.g., each proxy), a list of XR flows that are allowed to be proxied.

At 16, the UPF/proxy may send an XR flow session establishment response to the WTRU, indicating the success or failure of the operation.

In an example, methods and/or processes described herein may be performed while an XR flow session is open.

At 17, the WTRU and/or WTRU application may mark PDU sets and packets with XR service IEs. The WTRU application may apply XR services based on XR service IEs.

At 18, RAN/CN nodes (e.g., gNodeB) may apply XR services based on per-packet XR service IEs.

At 19, the AS/UPF may mark PDU sets and packets with XR service IEs. The AS/UPF may apply XR services based on XR service IEs.

At 20, The PDU set descriptors and data packets of the XR flows may be encapsulated in the proxied connection (e.g., in a MASQUE tunnel between the WTRU and UPF/proxy) and transmitted, switched, steered, or split over the PDU session between the WTRU and UPF/proxy.

At 21, XR flows may be forwarded by UPF/proxy to/from AS. This may be done with or without encapsulation, depending on whether any XR flow session establishment requests, AS updates, or XR flow establishment responses were performed.

A PDU set may be transmitted. At 22, the PDU set may be sent in the downlink by a non-legacy AS or by a UPF. In such a case, the UPF or AS may perform PDU set classification and send a PDU set descriptor message, e.g., in an HTTP datagram (e.g., unreliable HTTP datagram) or CAPSULE message over a reliable stream, including per-PDU set XR service IEs. UPF/AS may send PDU set data packets, e.g., in HTTP datagrams (e.g., unreliable HTTP datagrams). Network/CN nodes (e.g., the RAN) and the WTRU may read per-packet XR service IEs in the header (e.g., IP header) and apply XR services to the PDUs using the XR service IEs. XR services may include packet prioritization, synchronization, and/or jitter adjustments. The network/CN nodes (e.g., the RAN) may use per-flow XR service IEs or per-PDU set XR service IEs provided by the WTRU to apply XR services. The WTRU may send the per-flow XR service IEs or per-PDU set XR service IEs to the RAN node so that the RAN node may apply XR services to the PDUs of the PDU set. For example, the WTRU may send the per-flow XR service IEs or per-PDU set XR service IEs to the RAN node via an RRC message. In examples, the WTRU may send the per-flow XR service IEs or per-PDU set XR service IEs to the RAN node in UL MAC CE or UCI. In examples, the WTRU may be configured via RRC to report the per-flow XR service IEs or per-PDU set XR service IEs to the RAN node periodically and/or on an event-triggered basis (e.g., when detecting a change in any information/parameters carried in the XR service IEs or associated with the XR service IEs). The network/CN nodes (e.g., the RAN) may use per-flow XR service IEs or per-PDU set XR service IEs provided by the UPF to apply XR services. WTRU/UPF/AS may determine the message type (e.g., descriptor or data packet) and that they relate (e.g., one or more relate) to the same PDU set. In a MASQUE-based implementation, this may be achieved by using a MASQUE's context IDs. MASQUE may enable an endpoint (e.g., an endpoint) to generate unique context IDs. The data packets (e.g., one or more data packets) of a PDU set may be sent using a same, unique, and/or context ID. If PDU set descriptors are sent using PDU_SET_DESCRIPTOR CAPSULE messages (e.g., reliable PDU_SET_DESCRIPTOR CAPSULE messages), PDU_SET_DESCRIPTOR messages may include a related context ID IE that holds the context ID of the PDU set datagrams it relates to. If PDU set descriptors are sent using HTTP datagrams (e.g., unreliable HTTP datagrams), they may use a context ID derived from the context ID used for related PDU set data packets. For example, data packets context ID and descriptor context ID may differ by the value (e.g., only by the value) of their most significant bit(s) (MSB). It may be possible for the receiving WTRU/UPF/AS to associate a PDU set descriptor and PDU set packets (e.g., all PDU set packets) to the same PDU set and to apply an XR service to the PDU set. If a PDU set sequence numbering space declaration IE was provided in the XR flow establishment request), both WTRU and UPF may derive one or more per-PDU set XR service IEs, such as priority and type, from the context ID. In such a case, the PDU set XR service IEs may not be conveyed (e.g., need to be conveyed) in a PDU set descriptor. It may be possible to encode per-PDU set XR service IEs in the context ID, including one or more of the following: PDU set ID, PDU set priority, data type, PDU set length, etc. IEs encoded in context ID or derived from context ID may enable providing XR services, even in cases where the PDU set descriptor may be lost or late.

Another PDU set may be transmitted. At 23, the PDU set may be sent in the uplink by the WTRU. In such a case, a WTRU application or WTRU-hosted proxy client may perform PDU set classification and send a PDU set descriptor message, e.g., in an HTTP datagram (e.g., unreliable HTTP datagram) or CAPSULE message over a reliable stream, including per-PDU set XR service IEs. The WTRU-hosted proxy client, which may be hosted in the terminal equipment (TE) part of the WTRU, may send the PDU set classification information to the mobile termination (MT) part of the WTRU. For example, this may be done by invoking an AT command to communicate the information from the WTRU-hosted proxy client to the MT part of the WTRU. When the information may be communicated from the WTRU-hosted proxy client to the MT part of the WTRU, the WTRU-hosted proxy client may indicate what PDU session context the information may be associated with. The WTRU may use XR service IEs, including the per-PDU set XR service IEs when applying services to the PDUs of the PDU set. The WTRU may send the per-PDU set XR service IEs to the RAN node so that the RAN node may apply XR services to the PDUs of the PDU set. For example, the WTRU may send the per-PDU set XR service IEs to the RAN node via an RRC message. In examples, the WTRU may send the per-PDU set XR service IEs to the RAN node in UL MAC CE or UCI. In examples, the WTRU may be configured via RRC to report the per-PDU set XR service IEs to the RAN node periodically and/or on an event-triggered basis (e.g., when detecting a change in any information/parameters carried in the XR service IEs or associated with the XR service IEs). The WTRU may send the per-PDU set XR service IEs to the system (e.g., 5GC) via a NAS-SM message so that the SMF may configure the UPF to apply XR Services to the PDUs of the PDU set. For example, the WTRU may send the per-PDU set XR service IEs to the AMF via a NAS-SM message and the SMF may configure the UPF via the N4 interface with information about how the packet may be prioritized. The WTRU-hosted proxy client may send PDU set data packets, e.g., in HTTP datagrams (e.g., unreliable HTTP datagrams). The PDU set that the WTRU-hosted proxy client may send to the MT for transmission may include the per-Packet XR service IEs in the IP, header. RAN and UPF may read per-Packet XR service IEs and apply XR services to the PDUs. XR services may include packet prioritization, synchronization, and/or jitter adjustments. When the PDU set may be sent to the MT part of the WTRU, the WTRU-hosted proxy client may send the per-Packet XR Service IEs to the MT part of the WTRU so that the WTRU may apply XR services to the PDU. For example, as described herein, the WTRU may detect that transmission of another PDU from the same PDU set failed and may decide not to transmit this PDU set. The MT part of the WTRU may indicate to the WTRU-hosted proxy client that transmission of the PDU may not be attempted and that transmission of the PDU set may be considered aborted/a failure.

The XR proxy that may be hosted in the UPF or in the N6-LAN may determine the message type (e.g., descriptor or data packet) and that they relate (e.g., all relate) to the same PDU set. In an exemplary MASQUE-based implementation, this may be achieved by using a MASQUE's context IDs. MASQUE may enable an endpoint (e.g., each endpoint) to generate unique context IDs. Data packets (e.g., all data packets) of a PDU set may be sent using a same, unique context ID. If PDU set descriptors are sent using PDU_SET_DESCRIPTOR CAPSULE messages (e.g., reliable PDU_SET_DESCRIPTOR CAPSULE), the PDU_SET_DESCRIPTOR messages may include a related context ID IE that holds the context ID of the PDU set datagrams it relates to. If PDU set descriptors are sent using HTTP datagrams (e.g., unreliable HTTP datagrams), they may use a context ID derived from the context ID used for related PDU set data packets. For example, data packets context ID and descriptor context ID may differ by the value (e.g., only by the value) of their MSB. It may be possible for the receiving WTRU/UPF/AS to associate a PDU set descriptor and PDU set packets (e.g., all PDU set packets) to a same PDU set and to apply an XR service to the PDU set. If a PDU set sequence numbering space declaration IE was provided in XR flow session establishment request, both WTRU and UPF may derive one or more per-PDU set XR service IEs, such as priority and type, from the context ID. In such a case, the PDU set XR service IEs may not be conveyed (e.g., need to be conveyed) in a PDU set descriptor. It may be possible to encode per-PDU set XR service IEs in the context ID, including one or more of the following: PDU set ID, PDU set priority, data type, PDU set length, etc. IEs encoded in context ID or derived from context ID may enable providing XR services, even in cases where the PDU set descriptor may be lost or late.

In FIGS. 3A-3E, the WTRU app may be a legacy application. In examples, the WTRU app may (e.g., may explicitly) exchange XR service IE with WTRU/UPF. The XR WTRU app may send, after the WTRU app decides to request XR service for one or more flows, an XR flow establishment request (e.g., same message as described in XR flow session establishment request as described herein) to a local proxy on the WTRU (e.g., XR proxy client component on WTRU offering an XR proxy server interface to local WTRU apps). Based on completing the XR flow session establishment response, the local proxy on the WTRU may send an XR flow establishment response to the XR WTRU app. As a result, from this point on, the WTRU app may exchange XR services IEs with the local proxy. The XR services IEs may be exchanged along the chain of proxies between the WTRU app and AS. In examples, instead of using a proxied connection between the WTRU app and WTRU to communicate XR service IEs, the WTRU app may use a programmatic application programming interface (API) (e.g., function calls) to communicate XR services to the WTRU.

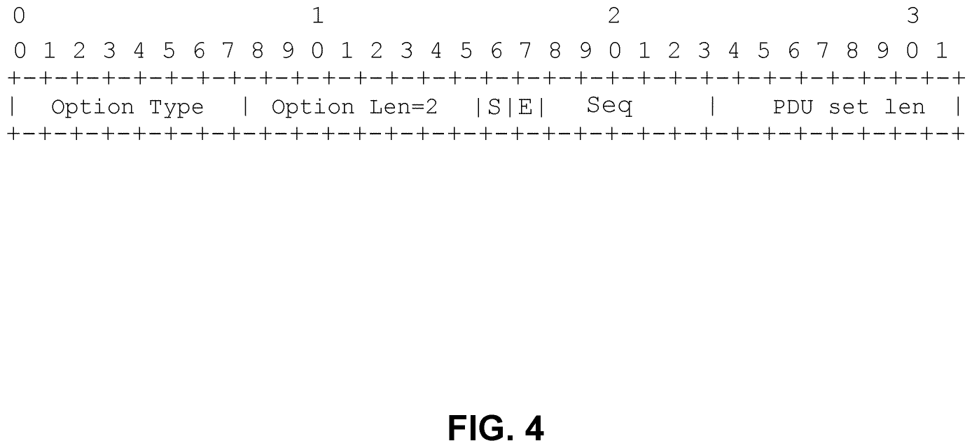

FIG. 4 shows an example of a PDU set option. A PDU set option in the IP header may be provided. The outer IP, e.g., IPv6, header may include a hop-by-hop or destination option header, including a PDU set option TLV. For example, as described with respect to FIG. 4, a short PDU set sequence option may include one or more of the following besides the option type and length: a start(S) flag, set on the first PDU of the set, an end (E) flag, set on the last PDU of the set, a PDU sequence number (Seq), or a PDU set length (e.g., number of packets).

Additional option types may be defined to carry additional or different per-packet XR service IEs, including a larger sequence number space (e.g., 14, 22, 30 bits) and/or a parent PDU set sequence number. Similarly, IPv4 PDU set options may be defined.

A CAPSULE protocol extension for XR services may be provided. One or more of the following CAPSULE protocol messages may be described to support procedures described herein. The CAPSULE protocol messages may include PDU_SET_DESCRIPTOR message type, which may include one or more of the following: the parameters, which may include context ID used by the HTTP datagrams carrying data packets for the PDU set related to this PDU set descriptor and/or one or more per-PDU set XR service IE as described herein; the sender which may include client or proxy (e.g., WTRU, UPF or AS); the receiver which may include client or proxy (e.g., WTRU, UPF, or AS); cause for sending (e.g., this message may be sent ahead of/along with transmitting data packets for a PDU set); action upon reception (e.g., the receiver may store the per-PDU set XR service IEs and associate them with the PDU set data packets such as PDU set data packets associated with the context ID which enables the receiver to perform XR services on the PDU set); or other aspects (e.g., this capsule may be sent on a reliable stream or unreliable datagram, and the packet carrying this capsule may be marked using a high-priority DSCP codepoint to minimize losses). CAPSULE protocol messages may include CLOSE_PDU_SET message type, which may include one or more of the following: parameters which may include context ID used to identify the PDU set to stop transmitting; sender, which may include client or proxy (e.g., WTRU, UPF or AS); receiver which may include client or proxy (e.g., WTRU, UPF or AS); cause for sending (e.g., the sender wishes its remote peer to stop sending packets related to a PDU set); or action upon reception (e.g., the receiver stops sending packets of the PDU set identified by the context ID).

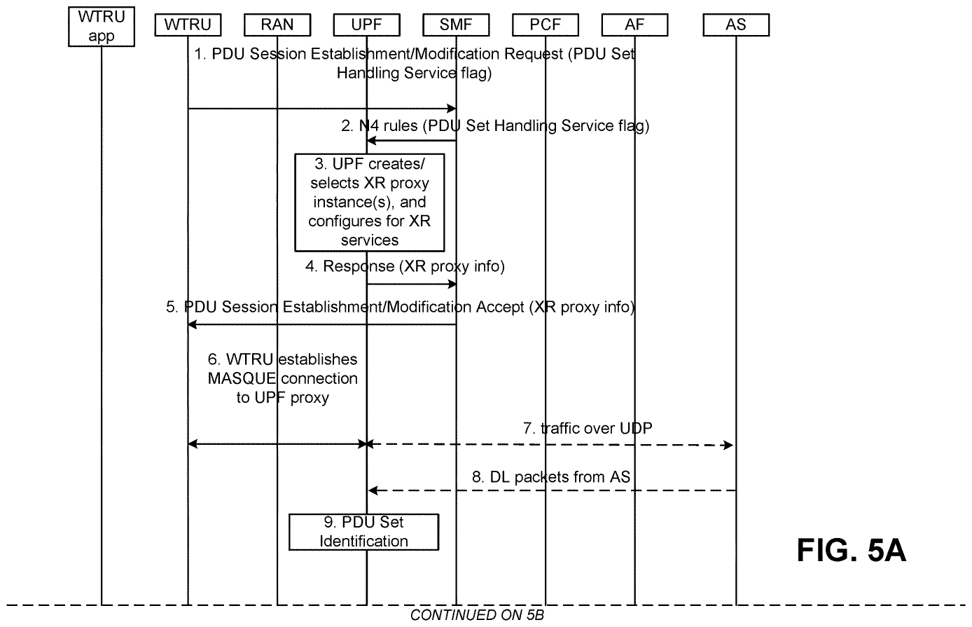

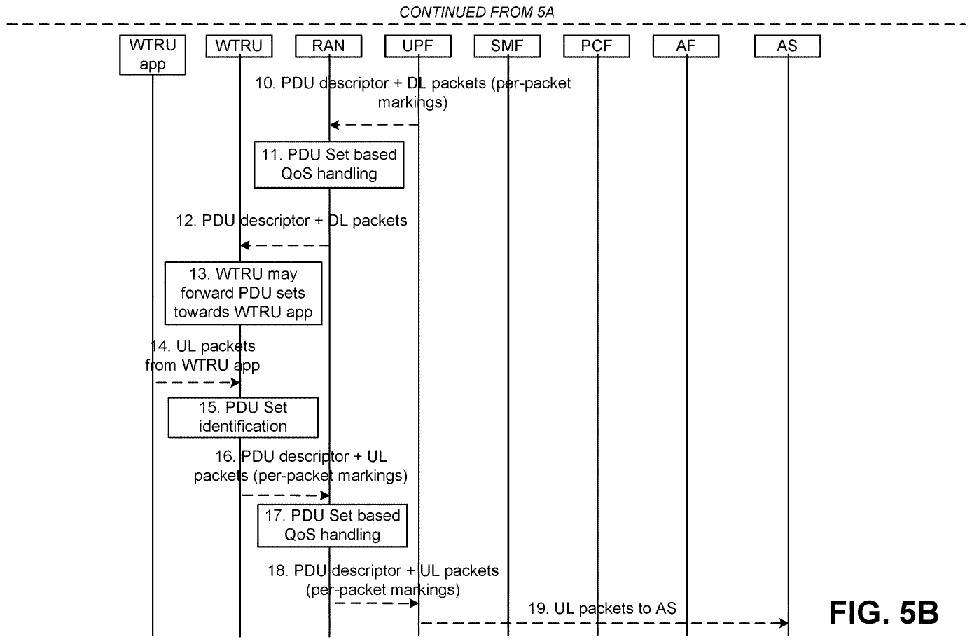

FIGS. 5A and 5B show an example procedure of a MASQUE-based PDU set-based QoS handling. UL and DL XR traffic may be supported, including cases where the WTRU and AS exchange XR traffic and WTRU1-WTRU2 peer-to-peer links. A PDU set handling service (e.g., a set of XR services applied to PDU sets, as described herein) may be provided in the WTRU, and in the UPF.

The WTRU may host a PDU set handling service proxy client. The UPF may host a PDU set handling service proxy server. A tunnel may be established to carry XR flows between a proxy client and proxy using the MASQUE protocol, which may rely on HTTP/3 over QUIC and supports the proxying of UDP flows. The HTTP/3 protocol may be defined in draft-ietf-quic-http and the extensions defined in one or more of the following: draft-ietf-masque-connect-udp for supporting UDP proxying over HTTP; draft-ietf-masque-h3-datagram for supporting HTTP datagrams; or draft-ietf-httpbis-h3-websockets for supporting Extended CONNECT. The QUIC protocol may be defined (e.g., in the IETF specifications RFC 9000, RFC 9001, RFC 9002 and the extension defined in RFC 9221) for supporting UDP proxying over HTTP. In the WTRU, the proxy client may be an HTTP/3 client. In the WTRU, the proxy server may be an HTTP/3 proxy. Once a HTTP/3 connection has been established between the proxy client and the proxy server, the proxy client may allocate a bidirectional HTTP data stream for a data flow (e.g., each data flow). A bidirectional HTTP data stream (e.g., each bidirectional HTTP data stream) may be established by the proxy client sending an extended CONNECT to the proxy server to establish a session for the flow. Once the HTTP data stream is set up for a data flow, the proxy client and proxy server may send to each other data packets in unreliable HTTP datagrams. A data packet (e.g., each data packet) may carry a PDU or information about the PDU set. The proxy client and server may perform PDU set identification of inbound traffic (e.g., of UL traffic on WTRU and DL traffic on UPF).

The PDU set handling service may be configured with different granularities. For example, one or more of the following may apply. Per-flow information (e.g., per-flow XR service IEs) may be exchanged between the proxy client and proxy server using MASQUE, e.g., using the extended CONNECT request and response. This information may include a flow descriptor (e.g., an IP 3-tuple describing the flow between the WTRU and XR application server). Per PDU set information (e.g., per-PDU set XR service IEs) may be exchanged between the proxy client and proxy server. Per PDU set information, when sent by a WTRU to a UPF, may make it possible for the UPF to handle the PDU set (e.g., transmit it towards AS or another WTRU) without re-generating the PDU set information from application headers (e.g., or without requiring the entire PDU set information to be present in all packets). The distinction between sending per PDU set information over the proxied connection and sending per PDU information at a lower layer may enable optimization(s) of per PDU information to be designed to reduce overhead without impacting PDU set information received by the WTRU or UPF. This information may include one or more of the following: information for intra-PDU set handling (e.g., PDU set sequence number (SN), start/end PDU of the PDU set, PDU SN within a PDU set, and/or number of PDUs within a PDU set); or information for inter-PDU set handling (e.g., PDU set importance and/or PDU set dependency). PDUs may be communicated between the proxy client and proxy server. Per PDU information (e.g., per-packet XR service IEs) may be sent with a PDU (e.g., each PDU) and may be visible to the RAN. Per-PDU markings may be set by the WTRU for UL traffic and by the UPF for DL traffic. In the DL, the UPF may populate the GTP-U header with information that may be used by the RAN for PDU set handling. In the UL, the WTRU may include the per PDU information in the PDU header which may be visible to the RAN. This information may include a PDU set first packet flag and/or last packet flag PDU sequence number (e.g., within the PDU set).

If the per PDU set information (e.g., any of the Per PDU set information) may be useful to the RAN, it may be included in the per PDU information (e.g., the PDU Header). What information may be encoded in the PDU header (e.g., whether the information may be useful to RAN) may be left to RAN WGs. How the PDU header may be encoded in the PDU may be left to stage-3 (e.g., encoded using IP header options, DSCP code points, or other techniques).

As shown in FIGS. 5A and 5B, the techniques may include one or more of the following. At 1, The WTRU may establish a PDU session. The WTRU may provide a PDU set handling service flag to request the PDU set handling service on this PDU session. At 2, the SMF may send the N4 rules to UPF, including an indication that the PDU set handling service may be requested and N4 rules that include extensions to support PDU set related handling. At 3, the UPF may configure a proxy server (e.g., create/select an XR proxy instance(s)) to provide the requested PDU set handling service.

At 4, the UPF may send the proxy server information (e.g., IP address and port of the proxy server instance) to the SMF to be used by the WTRU to connect to the proxy. The proxy server information may be included within or indicated by a response message that may be sent to the SMF.

At 5, the SMF may send a PDU session establishment accept message. The PDU session establishment accept message may include the IP address and port number of the proxy server. The N2 message may include QoS profiles and an indication that the PDU set handling service may be enabled. The QoS profile may include extensions to support PDU set-related handling.

For a flow (e.g., each flow), the proxy client may use the IP address and port number that were received in the PDU establishment accept message to establish a MASQUE connection with the proxy server. The MASQUE connection may be established at 6. The proxy client may initiate a MASQUE session (e.g., each MASQUE session) by sending an HTTP CONNECT request, including a connect-udp protocol parameter and the per-flow information. The WTRU app may send and receive UDP payloads of XR flows (e.g., RTP and/or SRTP packets) to/from the WTRU. The proxy client may implement the PDU set handling service, including PDU set identification, and may forward encapsulated XR flows over MASQUE to/from the UPF. At 7, the UPF may forward UDP traffic to/from the AS, as described herein.

At 8, the AS may send DL packets to the UPF. At 9, upon receiving DL packets from the XR AS, based on received N4 rules or local configuration, the proxy server of the UPF may identify PDU sets and per-PDU set information listed herein by matching RTP/SRTP header and payload.

At 10, if the PDU may be the first PDU in the set, the server proxy may send a PDU set descriptor (e.g., and DL packets (per-packet markings)) to the proxy client. In the DL, the UPF may populate the GTP-U header with per PDU information that may be used by the RAN for PDU set handling.

At 11, the RAN may apply PDU set-based QoS handling using the per PDU information. At 12, a node associated with the RAN may send the PDU to the proxy client.

At 13, based on the reception of the PDU, the proxy client may forward the XR traffic to the WTRU. At 14, the WTRU app may provide a UL packet to the WTRU. At 15, when the proxy client receives UL traffic (e.g., at 14), the proxy client (e.g., the WTRU) may identify PDU sets and per-PDU set information in a manner similar to the UPF PDU set identification. If the PDU may be the first PDU in the set, the client proxy may send a PDU set descriptor to the server client.

At 16, in the UL, the WTRU may include the per PDU information in the PDU header, which may be visible to the RAN. The WTRU may apply PDU set-based QoS handling. At 17, the RAN may apply PDU set-based QoS handling.

At 18, the RAN may send a PDU set descriptor (e.g., and UL packets (per-packet markings) to the UPF. At 19, the UPF may send UL packets to the XR AS.

A Media-Over-QUIC protocol relay may be provided. The concept of extended reality (XR) may be applied to augmented reality (AR), virtual reality (VR), and mixed reality (MR). XR traffic may be associated with a round-trip latency, which may be around 50 ms. Round-trip latency may encompass pose-to-render-to-photon latency. Motion-photon latency may be around 20 ms.

A Media Over QUIC (MOQ) protocol may be a low-latency media delivery for ingestion and distribution of media. MOQ may apply to live streaming, gaming, and/or media conferencing, and may be extended to include XR cases. MOQ protocols and mechanisms are described herein.

A MOQ relay may be an intermediary node in an end-to-end MOQ connection, for example, by acting as a forwarding proxy and providing services, for example, congestion management, or XR support service as described herein.

Techniques may be developed to improve QoS for XR applications, as well as to increase cell capacity and reduce energy usage for this type of application. Such support may involve (e.g., require) the network to have access to XR traffic metadata. While RTP/SRTP traffic may be analyzed (e.g., by UPF or the WTRU) to produce metadata usable by the network, encrypted traffic like MOQ may not be similarly analyzed by the network. Techniques for encrypted traffic may include analyzing traffic characteristics using machine learning algorithms.

Mechanisms for MOQ application endpoints to communicate, alongside XR media data, XR traffic metadata, may allow intermediate nodes (e.g., acting as MOQ relays) to provide a XR support service as described herein.

The mechanisms may use a secure MOQ relay for XR support located in the network and/or the WTRU (e.g., on I-UPF, PSA UPF, the WTRU, and/or the relay WTRU). A “secure MOQ relay for XR support” may be referred to as a “secure MOQ relay” or “MOQ relay.” To preserve the users'privacy, secure MOQ relays may be prevented, by end-to-end encryption, from accessing media data and metadata (e.g., most metadata). Secure MOQ relays may have (e.g., only have) access to metadata enabling the services they provide. These services may include traffic forwarding and/or XR support.

Secure MOQ relays may apply services on media flows. Such services may be referred to as MOQ services. In examples, an MOQ service may be an XR support service, where application endpoints may establish communication through a secure MOQ relay providing this MOQ service. An MOQ application endpoint (e.g., a media source located on a WTRU or AS) may send XR service IEs as described herein (also called herein XR metadata) alongside media data. The Secure MOQ relay may receive the XR service IEs and provide an XR service using these XR service IEs. An XR service may include one or more of the following: associating XR metadata with PDUs sent to the RAN to enable XR services by the RAN, locally prioritizing PDUs based on XR metadata in the case of congestion, select a path to forward PDUs when multiple paths are available between the MOQ relay and a next hop (e.g., the WTRU WTRU), or, in cases where the MOQ relay may be collocated with a WTRU, or in cases where the MOQ relay may be collocated with a RAN node (e.g., MOQ relay in UPF collocated with RAN node), perform local RAN XR services.

A MOQ protocol may carry media data (e.g., live media segments) over a QUIC-based transport protocol. The MOQ protocol may adjust media transfer rate based on a transport congestion control function internal state, e.g., reducing rate when experiencing congestion on a connection. Different types of congestion control algorithms may be supported (e.g., loss-based and/or delay-based) and different types of codecs may be supported, including codecs for XR video, e.g., immersive video (e.g., MIV), video-based point cloud compression (V-PCC) and/or geometry-based point cloud compression (G-PCC). Examples of MOQ protocols may include existing QUIC-based media streaming protocols such as RUSH and WARP.

A MOQ protocol may be carried over a WebTransport session or over a raw QUIC connection. Peers may agree on using the MOQ protocol through convention (e.g., out-of-band knowledge about the target URL to access the service), or signaling (e.g., a “moq” scheme in URL, Application-Layer Protocol Negotiation (ALPN), HTTP or QUIC settings parameter, a capsule message sent over the WebTransport session designating the MOQ protocol, etc.). The MOQ protocol may carry control messages (e.g., including media requests PDU set descriptor messages as described herein) over HTTP/QUIC streams and may carry media data and related metadata over HTTP/QUIC streams and/or datagrams. For MOQ over WebTransport, HTTP/QUIC streams/datagrams may carry a WebTransport session ID used to associate them with the appropriate WebTransport session.

Procedures for MOQ over WebTransport may be described herein. These procedures may be used to derive similar procedures that may be applicable to MOQ over raw QUIC.

A direct MOQ connection (e.g., not involving a MOQ relay) between a client/WTRU (e.g., a JavaScript application running in a browser on a WTRU) and a server/AS may include one or more of the following. The WTRU may establish an HTTP/3 connection with the AS, where both the WTRU and AS set the HTTP setting “SETTINGS_ENABLE_WEBTRANSPORT”. To start a WebTransport session over this HTTP/3 connection, the WTRU may send an extended HTTP CONNECT message to the AS, including parameters “protocol” (e.g., with value “webtransport”), “scheme” (e.g., “https”), “authority” set to the media server domain (e.g., media.example.com), “path” identifying the media to transmit (e.g., path/to/media), and/or “Origin” set to the web origin for the request. Based on reception, the AS may determine if the request may be accepted for the given web origin. If it may be accepted, the AS may send an HTTP response (e.g., 200 OK) to the WTRU. The requested WebTransport session may exist and may be identified with a session ID (e.g., equal to the stream ID used by the extended HTTP CONNECT request starting the session). The WTRU and AS may, over this session, exchange control messages, media data and/or associated metadata.

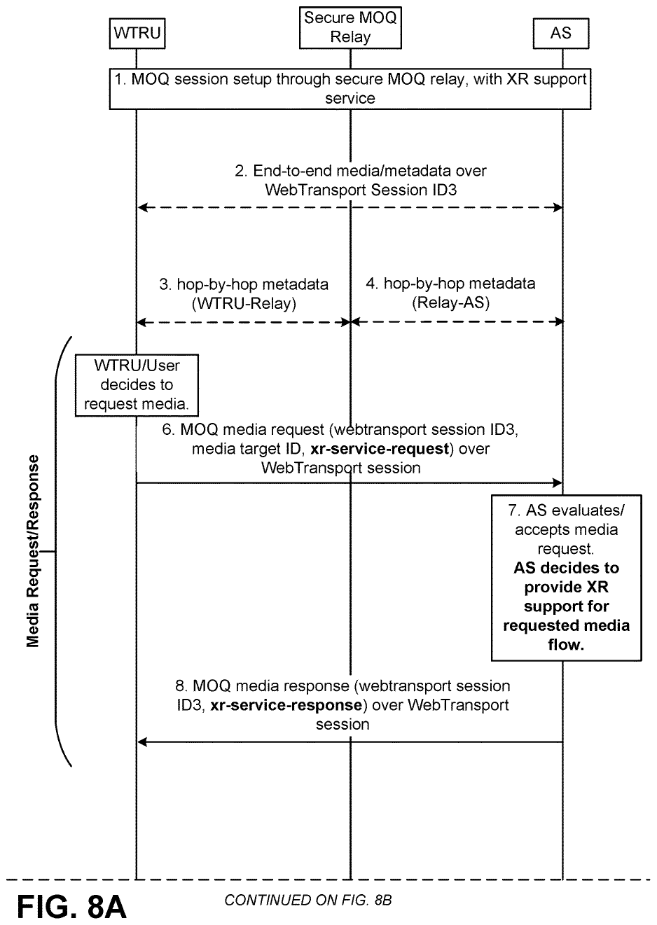

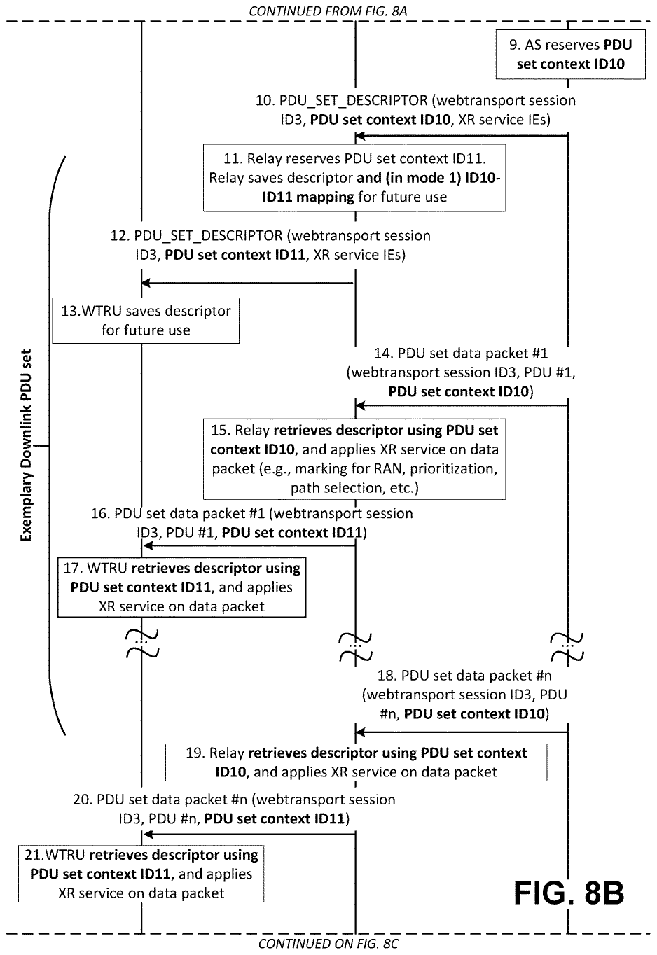

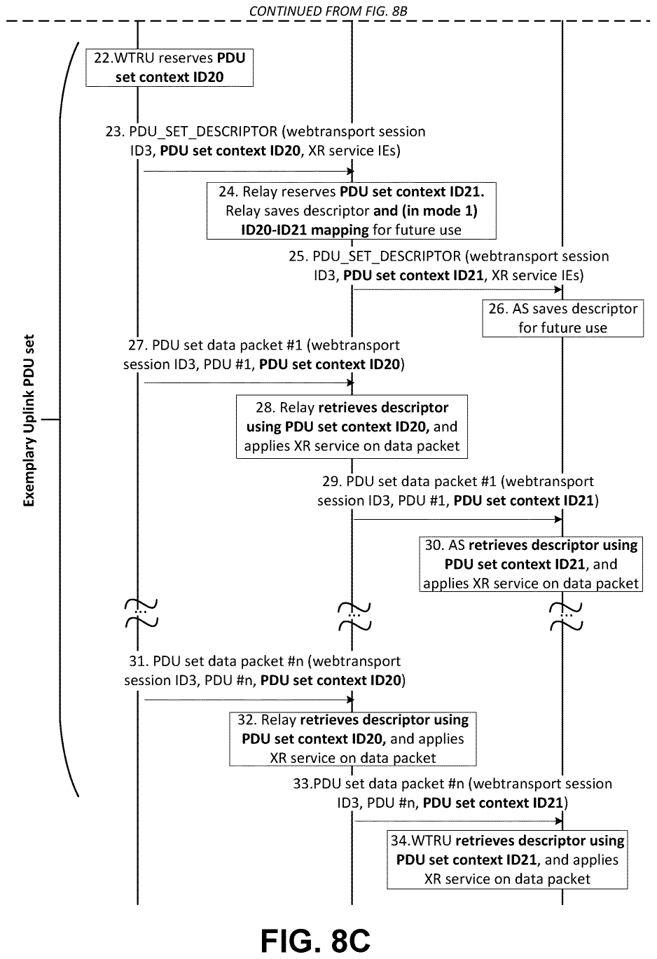

To receive support for XR media flows, an MOQ application may expose information to the network on the relative importance/relationship of different data units (e.g., PDU sets) within a flow. For example, within a video flow, an application may associate different priorities and interdependence information with I-frames, P-frames, and B-frames. Another application may associate this information with other kinds of application data units, as determined by the application (e.g., layers when using a scalable video codec). By setting different PDU set priorities, the application may ask the network to prioritize data units that may be useful for the Quality of Experience of end users. By setting interdependence information, the application may enable the network to drop PDUs that are useful for the Quality of Experience of end users (e.g., drop PDUs that depend on a base layer that was lost for their decoding). For example, an application may call a MOQ library function send_application_unit( ), with parameters including a media application unit, a priority, PDU set or application unit interdependence information, and other XR service IEs. As a result of this call, the MOQ library may send XR service IEs and PDUs as described with respect to FIGS. 8A-8C.

XR service IEs may be sent along the media flows over MOQ and made visible to intermediary MOQ relays, e.g., collocated with the WTRU, D2D-relay WTRU, PSA UPF, I-UPF, and/or edge server. For example, XR service IEs may be sent in a header of media flow data datagrams and/or streams, or in separate messages associated with media flow datagrams and/or streams through the use of a common ID (e.g., a PDU set ID, media flow ID, context ID or stream ID). An MOQ relay may collect the information exposed by the application and perform a range of packet processing functions, including marking the related packets with information usable by the RAN to implement XR support. An MOQ relay may provide additional service beyond marking packets for RAN. An MOQ relay may perform local priority-based queue management based on PDU set importance. An MOQ relay may mark TOS/TC/FL fields on forwarded PDUs, to have the network classify them in distinct QoS flows. In a case where multipath QUIC (or other multipath mechanisms such as Access Traffic Steering, Switching, Splitting, ATSSS) may be used between a MOQ relay and a WTRU (e.g., or between two MOQ relays), an MOQ relay may forward PDUs over a path it selects among multiple available paths, e.g., based on PDU set IEs, for having the system classify the PDUs in distinct QoS flows based on a path characteristics (e.g., e.g., each path characteristics such as 5-tuple), and/or for having the system transmit the PDUs over distinct access technologies (e.g., 5G NR, WiFi). When PDUs are classified in distinct QoS flows, they may receive different QoS treatments.

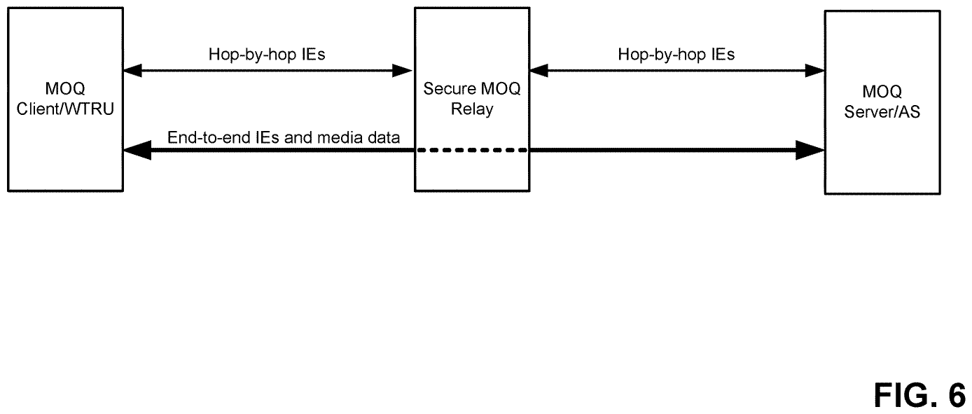

FIG. 6 shows an example of a secure MOQ relay model. FIG. 6 may represent the secure MOQ relay model, where hop-by-hop IEs may be exchanged between client/WTRU, secure MOQ relay, and server/AS (e.g., sent by an endpoint and forwarded by the relay, with or without modification, to the other endpoint). End-to-end IEs and media data may be exchanged between client and server (e.g., and protected through encryption from access by the secure MOQ relay which forwards them). Hop-by-hop IEs may include PDU set IEs, as described herein. End-to-end IEs and media data may be protected by (e.g., transport-layer) encryption between client and server. End-to-end IEs may include media request message IEs and metadata not related to the service provided by the secure MOQ relay (e.g., subtitles).

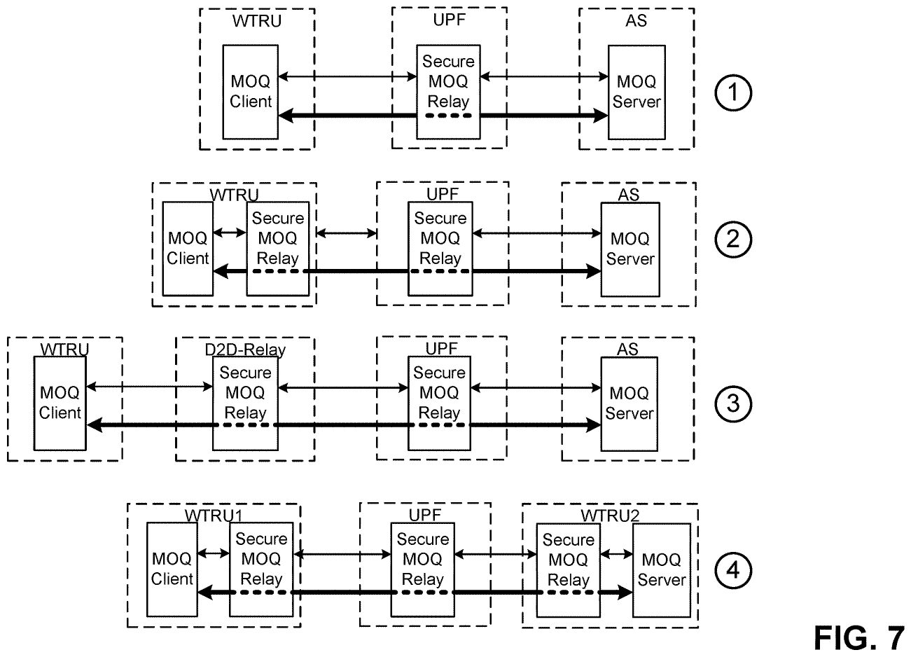

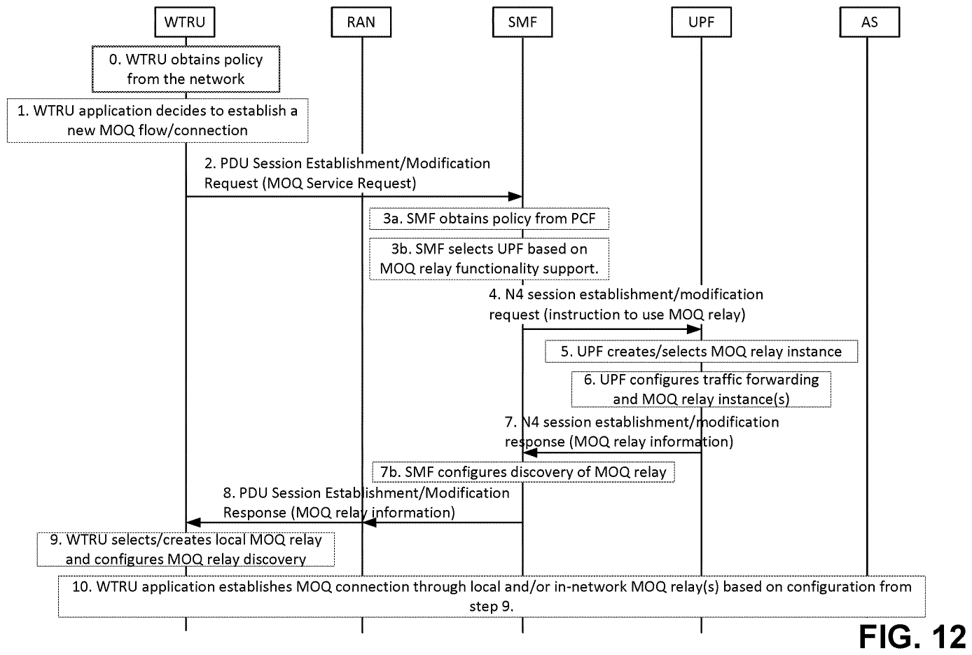

FIG. 7 shows an example deployment scenario for Secure MOQ Relays. These scenarios may represent clients, MOQ relays, and servers, and may represent hop-by-hop and end-to-end traffic flows as described with respect to FIG. 6. To use a given scenario, MOQ application client and MOQ relays may be configured with their next hop (e.g., MOQ relay or AS) to establish a communication chain. The procedure as described with respect to FIG. 12 may describe a technique where the network provides such configuration, e.g., based on policy set by the application provider. In scenario (1), a secure (e.g., a single secure) MOQ relay, collocated with a UPF (e.g., in UPF, in Network Function, or in edge computing server) may be used between a WTRU/MOQ client and an AS/MOQ server. This may be used to apply an XR service on downlink media stream from the AS. In examples, e.g., when AS may be in a Local Area Data Network, the secure MOQ relay may be collocated with a UPF and a gNodeB. In scenario (2), secure MOQ relays may be collocated with both WTRU and UPF. This may be used to apply an XR service on downlink and uplink media streams. In scenario (3), secure MOQ relays may be collocated with both a D2D-relay WTRU and UPF. This may be used to apply an XR service between the D2D-relay WTRU and UPF on downlink and/or uplink media streams. In scenario (4), secure MOQ relays may be collocated with WTRU1, WTRU2 and UPF. This may be used to apply an XR service on downlink and uplink legs of a peer-to-peer (e.g., WTRU1-to-WTRU2) media stream.

In the scenarios described herein, an MOQ client (e.g., a WTRU) may establish a connection to an MOQ server (e.g., an AS) through secure MOQ relays for XR support. If a MOQ relay rejects the connection (e.g., by closing the connection), a MOQ client may connect to the AS directly without using a relay. This may result in degraded service quality. The application provider may determine scenario (e.g., a suitable scenario) based on the nature of the application or based on the nature of the application feature used by the user (e.g., the user may be consuming downlink AR traffic, leading to scenario (1); the user may be producing uplink VR traffic, leading to scenario (2)). The application provider may configure the scenario in the system, e.g., through a NEF API. The system may store the scenario configuration from the NEF API into a policy rule, e.g., PCC rule.

Communication through secure relays may be provided. Types (e.g., two types) of secure MOQ relays may be described herein: an MOQ relay over MASQUE and an MOQ relay using end-to-end encryption keys. The MOQ protocol design may correspond to mode 2.

MOQ relay tunnel mode over MASQUE (e.g., referred to as “mode 1” herein) may overlay end-to-end communication over a MASQUE connection, therefore protecting, through end-to-end encryption, MOQ media data and metadata from being exposed to secure MOQ relays. The client/WTRU may establish a MASQUE session with a secure MOQ relay and the MOQ relay may establish a MASQUE session with a MOQ server (e.g., by forwarding the initial CONNECT request from the client towards the server). An MOQ relay may forward end-to-end traffic (e.g., application PDUs encapsulated in HTTP datagrams) between endpoints over the MASQUE sessions. In mode 1, secure MOQ relays may use metadata exposed over the MASQUE sessions to provide their service. Client/WTRU, Server/AS, and MOQ relays may communicate IEs used (e.g., needed) to provide services provided by the MOQ relay (e.g., including XR support service), using hop-by-hop messages, e.g., using the capsule protocol (e.g., TLV messages) over the MASQUE sessions.

MOQ relay “HTTP-intermediary mode” using end-to-end encryption keys (e.g., referred to as “mode 2” herein) may use the MOQ relay as an HTTP intermediary, but may use end-to-end encryption keys, e.g., exchanged out-of-band using a protocol such as Messaging Layer Security (MLS) to protect media data and some metadata end-to-end, while some metadata may be visible by the MOQ relay, but possibly authenticated end-to-end using the pre-shared keys.

MOQ design for XR support when using Secure MOQ relays may be provided. Combining WebTransport, mechanisms such as described with respect to FIGS. 3A-3E, MASQUE (e.g., in mode 1) and/or end-to-end encryption (e.g., in mode 2), and techniques described herein may enable efficiently providing XR support through secure MOQ relays. For example, PDU set descriptor messages may not be sent over a MOQ session in mode 1 and may not be sent encrypted end-to-end in mode 2 because secure relays access (e.g., need to access) those messages. PDU set descriptors may be placed (e.g., need to be placed) in messages readable by a MOQ relay (e.g., CAPSULE message in MASQUE in mode 1 or unencrypted WebTransport CAPSULE message in mode 2) and may include (e.g., need to include) a PDU set context ID which corresponds to an ID present in media data PDUs and readable by a secure MOQ relay. A technique may be used to enable mapping PDU set descriptor messages and PDUs sent over MOQ through secure MOQ relays in such a way that secure MOQ relays may use them to provide XR support service. A WTRU application discovering, under the control of a network operator, a MOQ relay to use when establishing a connection to a MOQ server may be provided. A technique may be used (e.g., needed) to discover and establish communication through the MOQ relay(s) and enable a range of deployments as described with respect to FIG. 7.

Mechanisms using MOQ Relays for XR Support may be provided. An XR Service Operation through MOQ relays may be provided. As shown in FIGS. 8A-8C, an XR Service operation through a secure MOQ relay may be provided. A PDU set descriptor message may be used to associate XR metadata with a PDU set using a “PDU set context ID.” A PDU set descriptor message may be described herein, where the “context ID” parameter may be a “PDU set context ID” as described herein and where other parameters are one or more per-PDU set XR service IE as described herein. The “PDU set context ID” may have a 1-to-1 relationship with a “PDU set ID” that may be present in the PDUs (e.g., each PDU) of a given PDU set.

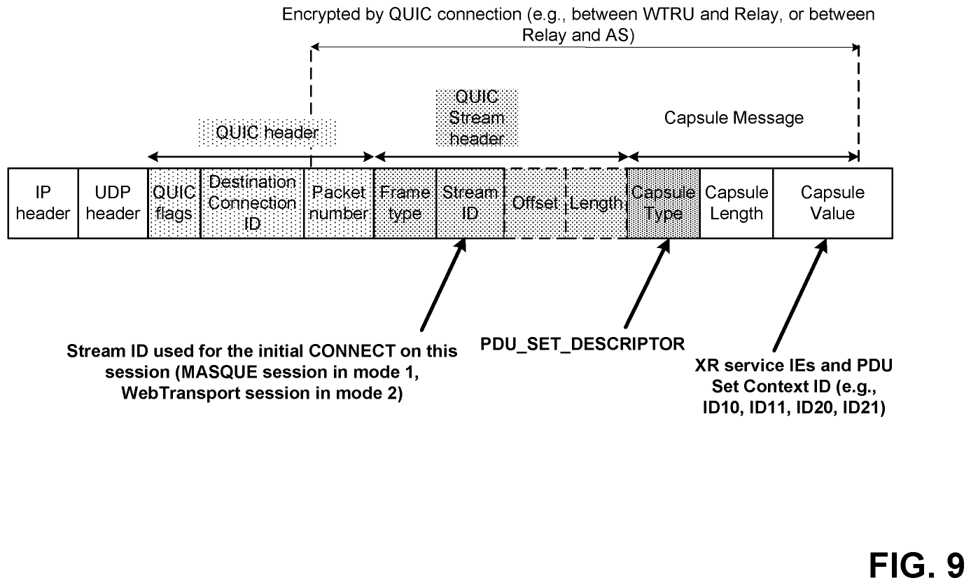

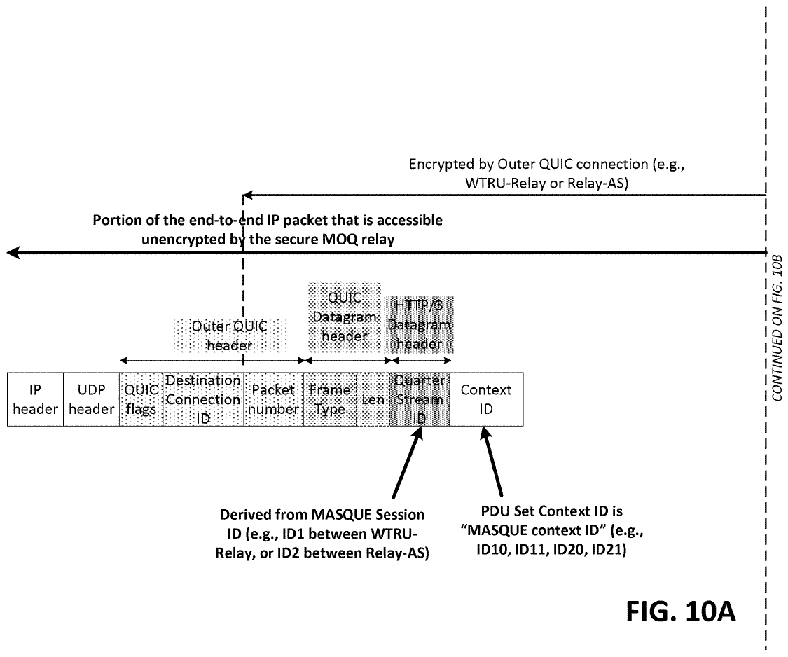

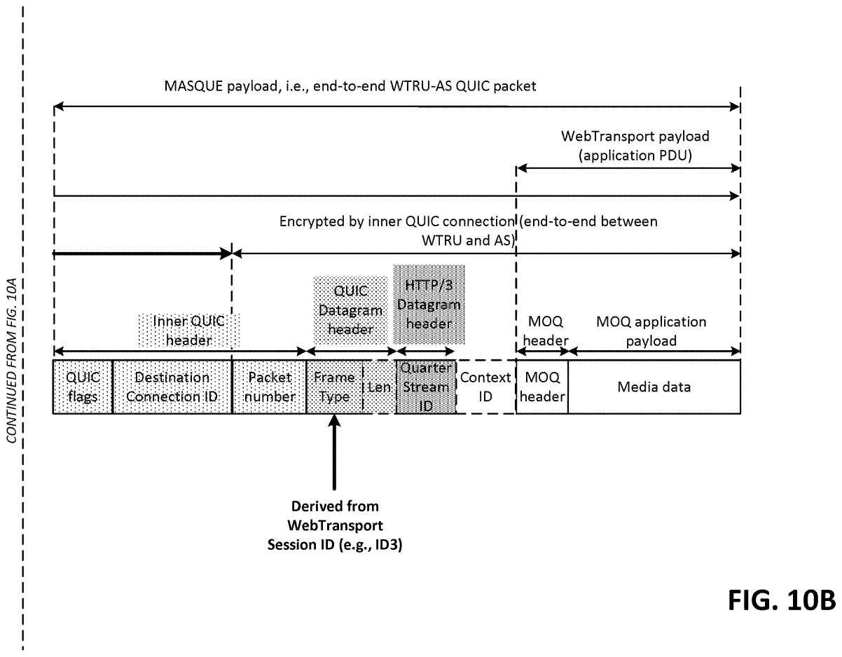

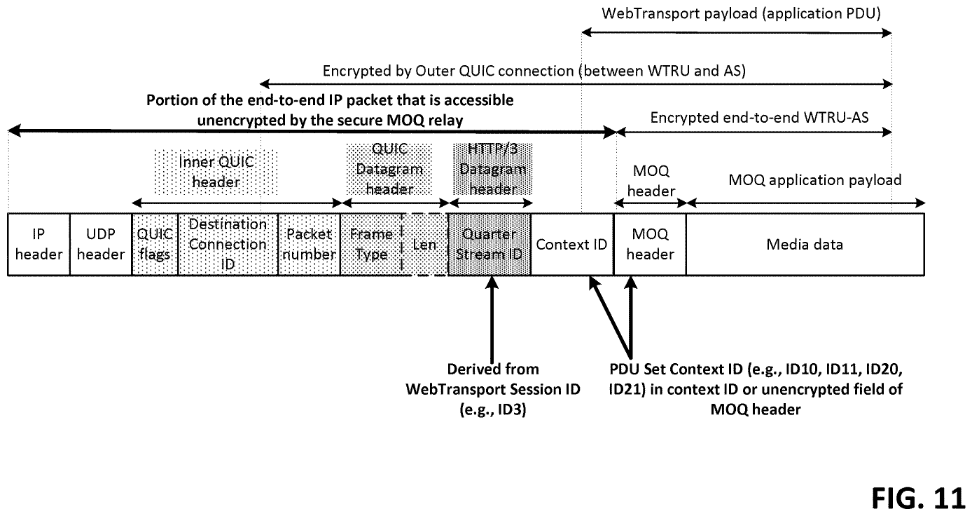

The relationship between a “PDU set context ID” and a “PDU set ID” may depend on the mode of operation and may be herein. Over the MOQ/WebTransport session, the MOQ application may send PDUs associated with a “PDU set ID.” The “PDU set ID” may be a (e.g., non-encrypted end-to-end) field in a MOQ protocol header, (e.g., if the PDUs of the PDU set are sent on a dedicated HTTP stream) a HTTP stream ID, or (e.g., if the PDUs of the PDU set are sent on HTTP datagrams identified with a context ID specific to this PDU set) an HTTP datagram context ID. In mode 2, this “PDU set ID” may be directly used as the “PDU set context ID” in the PDU set descriptor since the WTRU/AS/MOQ relay may have (e.g., all have) access to the “PDU set ID” in PDUs. In mode 1, the sender may maintain a mapping between the “PDU set ID” and a “MASQUE context ID” visible by the secure MOQ relay. The “MASQUE context ID” may be the context ID of HTTP datagrams encapsulating QUIC packets carrying PDUs of the associated “PDU set ID.” In mode 1, the MASQUE context ID may be used as the “PDU set context ID” in PDU set descriptor. In mode 1, Secure MOQ relays may establish and maintain mapping between MASQUE context IDs on a leg (e.g., each leg) of the connection. To illustrate the use of different IDs, FIG. 9 may represent a capsule message such as a PDU set descriptor. FIGS. 10A and 10B may represent an application PDU carried in mode 2. FIG. 11 may represent an application PDU carried in mode 1.

Similar other procedures may be derived from this procedure, involving a chain of secure MOQ relays (e.g., one collocated with WTRU and one collocated with UPF, or following other deployment scenarios such as described with respect to FIG. 7). A secure MOQ relay in the chain may be configured with a next hop secure MOQ relay if one exists. The procedure in FIG. 12 may represent how such a configuration may be performed.

FIGS. 8A-8C shows an example XR Service Operation through a secure MOQ relay. In FIG. 8A, at 1-4, a MOQ session may be set up between the WTRU and AS through a secure MOQ relay, possibly including XR service negotiation. For mode 1, both secure MOQ relay and AS may act as MASQUE proxies. The WTRU may establish a MASQUE session with the secure MOQ relay and the secure MOQ relay may establish a MASQUE session with the AS. The WTRU may establish a WebTransport session with AS, transported over the MASQUE sessions. The WTRU, MOQ relay and AS may exchange capabilities over the MASQUE sessions, including XR support service capability, during or after MASQUE session establishment. For mode 2, the WTRU and AS may exchange end-to-end encryption keys, e.g., using the MLS protocol. The WTRU may establish an HTTP connection with AS through the MOQ relay (e.g., acting as HTTP proxy). The WTRU may initiate a WebTransport session by sending an extended HTTP CONNECT request to AS through the MOQ relay. The WTRU, MOQ relay and AS may exchange capabilities over the WebTransport session during or after WebTransport session establishment, including XR support service capability. At this point, as illustrated at 2-4, a WebTransport session (e.g., identified by stream ID3) may be established over an HTTP connection between the WTRU and AS. Media data and end-to-end metadata may be encrypted end-to-end over the WebTransport session. Hop-by-hop metadata may not be encrypted and in cases may be updated by the secure MOQ relay. The part of the connection between WTRU and MOQ relay may be leg 1 and the part of the connection between MOQ relay and AS may be leg 2.

At 5-8, a media request/response initiated by the WTRU may be shown. The AS may send a media request to request an uplink media stream. At 5, the WTRU (e.g., based on a user interaction) may decide to request media. Different media flows (e.g., video, audio, etc.), which may contain (e.g., each contain) one or more types of PDU sets, may be requested over a single MOQ/WebTransport session, resulting in multiple media streams multiplexed over this session.

At 6, the WTRU may send a MOQ media request message over the WebTransport session ID3 (e.g., over a new HTTP stream associated with WebTransport session ID3). The MOQ media request message may include a media target ID. The MOQ media request message may include a XR-service-request IE (e.g., a Boolean flag) that indicates (e.g., if set to “true”) that XR Service IEs are requested for this flow. This IE may make it possible to request XR Service IEs on some flows and not others.

At 7, the AS may evaluate (e.g., and accept) the media request. The AS may choose to provide XR service IEs for the media flow based on the XR-Service-Request IE. If the XR-Service-Request IE is not provided in the MOQ media request, the AS may consider providing XR Service IEs on this flow (e.g., based on application logic or configuration, and type of media such as video, audio, text, etc.).

At 8, the AS may send a MOQ media response on a WebTransport session ID3. The MOQ media response may include an XR-Service-Response IE (e.g., a Boolean flag) to indicate that the AS may provide XR Service IEs associated with the requested media stream.

In FIG. 8B, 9-21 may relate to an exemplary downlink PDU set. The AS may send PDU set information. The AS may send the PDU set information reliably, asynchronously, and in advance. The AS may send PDUs corresponding to this PDU set.

At 9, the AS may determine the XR service IEs associated with a PDU set selected to be sent to the WTRU. The AS may reserve a PDU set context ID10. ID10 may be used to identify the selected PDU set. For example, the AS may determine ID10 by selecting the next unused PDU set ID.

At 10, the AS may send a PDU_SET_DESCRIPTOR message to a secure MOQ relay, including a PDU set context (ID10) and XR service IEs associated with the selected PDU set. In mode 1, the PDU_SET_DESCRIPTOR may be a Capsule protocol message sent over an HTTP stream of the MASQUE session between the AS and MOQ relay. In mode 2, the PDU_SET_DESCRIPTOR may be a Capsule protocol message sent over an HTTP stream of the WebTransport session ID3.

FIG. 9 shows an example representation of a capsule message to/from a secure MOQ relay (e.g., at 10 in FIG. 8B). As shown in FIG. 9, a detailed representation of the PDU_SET_DESCRIPTOR message, including stream ID, PDU_SET_DESCRIPTOR capsule type, XR service IEs, and PDU set context ID (ID10) may be provided. One or more fields may be represented using dotted lines to indicate they may or may not be present. At 10 in FIG. 8B, the packet may include the IP address and a UDP port, which may point to the secure MOQ relay. Based on receiving this message, the secure MOQ relay, based on the stream ID, may determine how to forward the message, retrieve the next hop (e.g., WTRU) IP address/port from the MASQUE (e.g., mode 1) or WebTransport (e.g., mode 2) session information.

Referring to FIG. 8B, at 11, a Secure MOQ Relay may save the PDU set descriptor (e.g., including XR service IEs and PDU Set Context ID10) for use (e.g., future use). In mode 1, a secure MOQ Relay may reserve a MASQUE context ID/PDU set context ID11 in the WTRU-AS MASQUE session. The Secure MOQ Relay may save a mapping between PDU Set Context ID10 and PDU Set Context ID ID11. In mode 2, the same PDU set context ID may be used on both legs 1 and 2 (e.g., since in this mode, the PDU set context ID may be a stream/context/PDU set ID of the end-to-end WebTransport session). In mode 2, PDU set context ID10 and ID11 may be the same ID.

At 12, the Secure MOQ Relay may send a PDU_SET_DESCRIPTOR message to the WTRU, including XR service IEs and PDU Set Context ID11. At 13, the WTRU may save the PDU set descriptor (e.g., including XR service IEs and PDU Set Context ID11) for use (e.g., future use). At 14, the AS may send a first PDU #1 that may be part of the PDU set related to ID10/ID11. PDU #1 may be sent over the WebTransport session ID3.

FIGS. 10A and 10B show an example representation of a PDU sent over MOQ using a secure MOQ relay in mode 1 (e.g., which may be used at 14 in FIG. 8B). In mode 1, FIGS. 10A and 10B may provide a detailed representation of the PDU, including MASQUE session ID, PDU set context ID10, and WebTransport session ID3.

FIG. 11 shows a representation of an example of a PDU sent over a MOQ using a secure MOQ relay in mode 2 (e.g., which may be used at 14 in FIG. 8B). In mode 2, FIG. 11 may provide a detailed representation of the PDU, including PDU set context ID10 (e.g., which may be the PDU set ID), and WebTransport session ID3. One or more fields may be represented using dotted lines to indicate they may or may not be present. The MOQ header may include fields such as a timestamp, a start of frame indicator, an end of frame indicator, a layer ID, XR service IEs, etc. One or more fields may be encrypted end-to-end, while other fields may not be encrypted end-to-end. In mode 2, the PDU set context ID may be encoded as an HTTP datagram context ID or a MOQ header field (e.g., not encrypted end-to-end).

Referring to FIG. 8B, at 15, the Secure MOQ Relay may retrieve, using the PDU set context ID10 from PDU #1, and the information stored at 11, the PDU set descriptor (e.g., containing XR service IEs) corresponding to PDU #1. The Secure MOQ Relay may use the XR service IEs from the retrieved PDU set descriptor to apply an XR service on PDU #1. As described herein, an XR service may include one or more of the following: marking PDU #1 prior to forwarding it towards the RAN to enable RAN to apply XR services on the PDU (e.g., by marking GTP-U header fields); selecting a path to forward PDU #1 over, if multipath QUIC may be used between secure MOQ relay and WTRU; marking PDU #1 IP header TOS/TC/FL prior to forwarding; performing local prioritization of PDU in case of congestion; performing local RAN optimization on WTRU when the MOQ relay may be collocated with the WTRU. In mode 1, the secure MOQ Relay may retrieve, using PDU set context ID10 from PDU #1 and the mapping information stored in step 11, the PDU set context ID11 to use when forwarding PDU #1. In mode 2, PDU set context ID11 may be equal to PDU set context ID10.

At 16, the Secure MOQ Relay may forward PDU #1 to the WTRU associated with PDU set context ID11. PDU #1 may be sent using markings and/or path selection as determined at 15. At 17, the WTRU may retrieve, using the PDU set context ID11 from PDU #1 and the information stored at 13, the PDU set descriptor corresponding to PDU #1. The WTRU may apply XR service as described herein. In an example where the WTRU is a relay for another client WTRU, the relay WTRU may use PDU set information to prioritize media data in case of congestion on the link between the client WTRU and relay WTRU.

14-17 may be repeated for a PDU (e.g., each PDU) in the PDU set, associated with PDU set context ID10 on leg 2 and PDU set context ID11 on leg 1. An exemplary PDU #n processing may be represented at 18-21.

In FIG. 8C, 22-34 may relate to an exemplary uplink PDU set. The WTRU may send PDU set information reliably, asynchronously, and in advance. The WTRU may send PDUs corresponding to this PDU set. 22-34 may be similar to and may be derived from 9-13. In mode 2, PDU set context ID20 and ID21 may be the same ID.

At 27, the WTRU may apply XR services prior to sending PDU #1. For example, the WTRU may mark layer-2 header fields of PDU #1 to enable RAN to apply uplink XR service techniques (e.g., adapt transmission reliability based on PDU set importance IE) or the WTRU may implement locally uplink RAN XR service techniques.

At 28, the nature of XR services provided by the secure MOQ relay may depend on the scenario. For example, if the server/AS is deployed on a WTRU, the secure MOQ relay may use GTP-U marking to enable RAN to provide XR services. In examples, if the server/AS may be deployed in a remote or edge cloud, the secure MOQ relay may mark forwarded PDUs IP header TOS/TC/FL fields. In example, the secure MOQ relay may apply priority when forwarding PDUs based on PDU set IEs, e.g., in case of congestion.

In examples, the media sender (e.g., the WTRU or AS) or MOQ relay may determine that a PDU set transmission may be canceled. For example, a cancellation may be made in response to a congestion event or the detection of a lost packet. In addition to the event itself, the WTRU/AS/MOQ relay may use XR service IEs related to PDU sets to select which PDU sets may be canceled. When a decision may be made, the WTRU/AS/MOQ relay may send a CLOSE_PDU_SET message to the WTRU, AS, and/or MOQ relays to request stopping transmission and dropping the selected PDU sets. In examples, e.g., in mode 2, when PDUs are sent using dedicated per-PDU-set HTTP streams, the WTRU/AS/MOQ relay may close (e.g., alternatively close) the stream instead of sending a CLOSE_PDU_SET message.

Connection Establishment and Discovery of Secure MOQ Relays may be provided. FIG. 12 MOQ relay discovery and connection establishment procedure may be used. Prior to this procedure (which may not be shown), the WTRU and AS may exchange end-to-end encryption keys, e.g., using MLS.

FIG. 12 shows an example MOQ relay discovery and connection establishment procedure. As shown in FIG. 12, a secure MOQ relay(s) discovery and connection establishment procedure may be provided. In this procedure, the WTRU and network, based on control plane signaling and policy, may determine the use (e.g., need) for secure MOQ relay(s), deploy secure MOQ relay(s), and communicate secure MOQ relay(s) IDs over the control plane, to enable the WTRU application and intermediate secure MOQ relays to be configured with the next hop MOQ relay. In an example, mode 2 may be used.

In an example, prior to this procedure (e.g., which may not be shown), the WTRU and AS may exchange end-to-end encryption keys, e.g., using MLS. At 0, the WTRU may obtain policy from the network. Such policy may be WTRU Route Selection Policy (URSP), WTRU Access Network discovery and selection policies (ANDSP), WTRU Vehicle-to-Everything Policy (V2XP) and/or WTRU 5G Proximity based Services Policy (ProSeP).

Policy rules may include “MOQ relay configuration IEs” including one or more of the following. They may include a relay/proxy type, e.g., an Application Layer Protocol Negotiation (ALPN) label “moq” to indicate a MOQ relay type. They may include an instruction (e.g., a flag) to set a “MOQ service request indication” in the connection establishment/update message. They may include an MOQ relay usage scenario identifier, with possible values indicating no relay, relay in network, relay in WTRU, and/or relay in network and WTRU. A MOQ relay usage scenario identifier may include values indicating a MOQ relay in UPF and D2D relay WTRU, or may include values indicating a MOQ relay in UPF and multiple endpoint WTRUs. This may make it possible to configure scenarios such as the ones in FIG. 7. Other encodings may be used, e.g., Boolean flags indicating the presence/absence of local and in-network MOQ relay. They may include additional MOQ relay protocol parameters, including a list of MOQ protocol extensions to be used, which may include an “XR-support” MOQ protocol extension (e.g., an extension or mode of operation of a MOQ protocol using PDU set descriptors and other XR service functionalities described herein.)

At 1, a WTRU application may decide to establish a MOQ flow/connection (e.g., new MOQ/ flow/connection). Based on a service request (e.g., when the application sends a first DNS request packet), the WTRU may select a URSP rule matching the URSP rule traffic descriptor (e.g., based on the WTRU application name) and may select a (e.g., highest precedence) Route Selection Descriptor (RSD) from this rule. If the selected RSD includes an instruction to add a “MOQ service request indication,” the WTRU may determine to add a MOQ service request indication in the PDU session establishment request/update at 2.

At 2, the WTRU may send a PDU session establishment request/update. Based on policy (e.g., at 0 and/or 1) and/or based on configuration or a WTRU application request, the WTRU may add a MOQ service request indication in the PDU session establishment request/update. The MOQ service request indication may be a MOQ service flag and/or one or more MOQ relay configuration IEs.

At 3a (e.g., or earlier), the SMF may obtain policy from PCF, e.g., including Policy and Charging Control (PCC) rules and session rules. These policy rules may include MOQ relay configuration IEs as described herein. Upon receiving the session request message, the first network node (e.g., the SMF) may determine policy information from a third network node (e.g., the PCF).

The SMF may (e.g., before obtaining policy from PCF) determine policy information from a third network node (e.g., the PCF). At 3a (e.g., or earlier), the SMF may obtain policy information from the PCF, e.g., including Policy and Charging Control (PCC) rules and session rules. At 3b, the SMF may select a UPF based on a MOQ relay configuration IEs in policy (e.g., PCC) rules, based on an MOQ service request indication in the message received at 2, based on the UPF capability to support a MOQ relay functionality and/or based on the UPF capability to support specific MOQ extensions such as “XR-Service” extension. An extension, as described herein, may refer to a feature that may be added to the MOQ protocol to support a functionality. A MOQ extension may be a feature added to the MOQ protocol, and an XR service extension may refer to a modification to the MOQ protocol that enables support for extended reality (XR) services. The SMF may be aware of UPF support of MOQ relay functionality and extensions based on local configuration and/or a management plane message from the operator (e.g., the PCF). The local configuration or management plane message may (e.g., explicitly) define the supported MOQ extensions and functionalities of the UPF (e.g., the support for specific MOQ protocol versions, XR services, or other MOQ-related features). The capability of the UPF (e.g., the second network node) may be (e.g., implicitly) determined based on provided information, such as hardware of the UPF (e.g., the second network node) or software specifications of the second network node, which may be used to infer the supported MOQ functionalities. For example, the local configuration or management plane message may include an indication that MOQ relays/proxies are supported by a UPF. In another example, the local configuration or management plane message may include an indication that this UPF supports XR traffic, and the SMF may derive from this information that MOQ relays/proxies are supported by the UPF. The first network node (e.g., the SMF) may determine the capability of the second network node (e.g., the UPF) for providing the network MOQ proxy based on a local configuration or a management plane message.

The second network node (e.g., the UPF) may be selected based on its capability to support a MOQ extension, such as an extended reality service (XR-Service) extension. The first network node (e.g., the SMF) may select the second network node (e.g., the UPF) based on the received MOQ service request and the second network node's capability to support MOQ proxy functionality. The SMF may be aware of UPF support of MOQ relay functionality and extensions based on local configuration and/or a management plane message from the operator. The UPF's capability to support MOQ relay functionality and extensions may be determined based on a local configuration or a management plane message. In the first network node (e.g., the SMF), a session request message may be received from a WTRU for a data session and a media over QUIC (MOC) service. The first network node may determine a MOQ proxy deployment, and a second network node based on the network proxy deployment. A proxy establishment message may be sent to the second network node by the first network node. A session establishment message may be sent to the WTRU by the first network node based on the local proxy deployment.

At 4, the SMF may send an N4 session establishment/modification request to the UPF, including an instruction to use a MOQ relay. This instruction may be an N4 rule IE and may hold a MOQ service flag and/or one or more MOQ relay configuration IEs. When sending the relay establishment message to the second network node, the first network node may transmit it through an N4 interface and include a MOQ service flag or MOQ relay configuration information element in the relay establishment message.

At 5, the UPF may create an MOQ relay instance (e.g., a new MOQ relay instance) and/or may select an existing MOQ relay instance for use with the PDU session. The created/selected MOQ relay instance may be referred to as an “in-network MOQ relay” instance. The in-network MOQ relay instance may be collocated with the PSA UPF, with an I-UPF, or with an NF. At 6, the UPF may configure traffic forwarding for the PDU session traffic using rules provided by SMF over N4. The UPF may configure the MOQ relay instance (e.g., to accept traffic from the WTRU's IP address). In determining the second network node (e.g., the UPF) to provide the MOQ service based on the network proxy deployment, the first network node (e.g., the SMF) may obtain MOQ proxy information from a session establishment response received from the second network node (e.g., the UPF), and the MOQ proxy information may include the following: a MOQ proxy IP address, a domain name, or a port.

At 7, the UPF may send an N4 session establishment/modification response to the SMF, including MOQ relay information IE. MOQ relay information IE may include one or more of the following: MOQ relay IP address, FQDN, (e.g., UDP) port, or MOQ relay configuration IEs.

At 7b, the SMF may use MOQ relay information IE from 7 to configure MOQ relay discovery. In examples, the SMF may configure an SRV record in a DNS server (e.g., an entry _moq.<operator-domain-name> pointing to ALPN “moq” label and the in-network MOQ relay IP address/FQDN/port). The first network node (e.g., the SMF) may include a MOQ proxy information element in the session establishment message sent to the WTRU. In examples, the SMF may configure other discovery techniques (e.g., other DNS-based or DHCP-based methods, etc.). This may be useful to enable discovery of the MOQ relay by the WTRU application (e.g., in case 1 in FIG. 7). The first network node (e.g., the SMF) may obtain network MOQ proxy information from the second network node (e.g., the UPF) in response to the proxy establishment message and configure a network MOQ proxy discovery method based on the network MOQ proxy information, enabling a WTRU application of the WTRU to discover the network MOQ proxy.

At 8, the SMF may (e.g., after obtaining network MOQ proxy information from the second network node in response to the proxy establishment message) send a PDU session establishment/modification response to the WTRU (e.g., through RAN), which may include MOQ relay information IE. At 9, the WTRU may determine if a local MOQ relay may be used (e.g., needed), e.g., based on MOQ relay configuration IEs from configuration/policy information and/or MOQ relay information IE from the PDU session establishment/modification response. For example, a local MOQ relay may be used (e.g., needed) if a MOQ relay usage scenario identifier may be set for a scenario with a local MOQ relay. If a local MOQ relay may be used (e.g., needed), the WTRU may select an existing local MOQ relay instance (e.g., or create a new one and select it). The WTRU may collect an IP address/FQDN/port of the selected local MOQ relay instance. The WTRU may configure the discovery of local MOQ relay by the WTRU application. For example, the WTRU may configure a DNS service (e.g., local DNS service on WTRU) with a service (SRV) record for a well-known entry in a domain (e.g., _moq.<local-domain-name>), with, e.g., ALPN “moq” label, and the local MOQ relay IP address/FQDN/port. In examples, the WTRU may configure other discovery techniques of local MOQ relay (e.g., updating the local configuration of the WTRU application, other DNS-based or DHCP-based methods, etc.) For the discovery of in-network MOQ relay, the WTRU may, in addition, or replacement of the configuration at 7b, configure other discovery techniques of in-network MOQ relay to enable WTRU application (e.g., or local MOQ relay if present) to discover the in-network MOQ relay (e.g., updating the local configuration of the WTRU application or local MOQ relay or using a local DHCP-based or DNS-based discovery technique).

At 10, a WTRU application may establish an MOQ connection with the AS. The WTRU application may discover MOQ relay information (e.g., IP address/FQDN/port) by sending a DNS request for SRV records (e.g., a first request for record “moq.<local-domain-name>,” and, if not successful, a second request for record “moq.<operator-domain-name>”). Based on reception of a DNS response including discovered MOQ relay information, e.g., ALPN “moq” label, IP address/FQDN/port, the WTRU application may initiate communication with the AS through the discovered MOQ relay. The WTRU application may use other techniques to discover a MOQ relay (e.g., local configuration, or other DNS/DHCP-based techniques).

If a local MOQ relay is used, based on receiving a connection request from the WTRU application, the local MOQ relay may discover the in-network MOQ relay using a similar technique (e.g., by sending a DNS request for SRV record “moq.<operator-domain-name>”).

The WTRU application may establish an MOQ connection with the AS through the in-network MOQ relay, for example, by establishing an HTTP connection with the in-network MOQ relay and sending an extended CONNECT request to the MOQ relay, specifying the AS FQDN and port as a destination. The in-network MOQ relay may forward the CONNECT request to the AS (e.g., over an MOQ relay-AS HTTP connection) to establish the end-to-end MOQ connection.

In a connection establishment, the WTRU application may establish an MOQ connection with the AS through the local MOQ relay. When sending a CONNECT request to the local MOQ relay, the local MOQ relay may forward the CONNECT request to the in-network MOQ relay, which forwards the CONNECT request to the AS.

The WTRU application, MOQ relay(s), and AS may negotiate extensions (e.g., if needed). For example, the WTRU may send a message to the AS, including a list of supported/requested extensions through MOQ relay(s). MOQ relay(s) may close the connection if it does not support the extensions. AS may reply with the same list of extensions to indicate its acceptance or a modified list of extensions. The WTRU may either accept the list of extensions in the reply or close the connection.

The WTRU application and AS may exchange media traffic over the MOQ protocol, for example, following the procedure described in FIGS. 8A-8C. The WTRU application and AS may use pre-shared end-to-end encryption keys to protect media and metadata.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A network node, the network node comprising:
a processor, the processor configured to:
receive, from a session management function (SMF), an N4 session request comprising an instruction to use a media over quick user datagram protocol internet connections (MOQ) relay functionality;
determine a MOQ relay instance and send MOQ relay information associated with the MOQ relay instance to the SMF;
receive a MOQ session establishment message from a wireless transmit/receive unit (WTRU) and establish, as a MOQ relay, a MOQ connection with the WTRU and an application server;
receive, from the application server, a MOQ protocol data unit (PDU) comprising PDU set information;
identify the PDU set information associated with the MOQ PDU; and
transmit a PDU to a radio access network (RAN) node, wherein the PDU set information is included in a GTP-U header of the PDU.

2. The network node of claim 1, wherein the instruction to use the MOQ relay functionality comprises at least one of a MOQ service flag or a MOQ relay configuration information element.

3. The network node of claim 1, wherein the MOQ relay information comprises at least one of a MOQ relay IP address, a fully qualified domain name (FQDN), or a port.

4. The network node of claim 1, wherein the MOQ relay instance is collocated with the network node, and wherein the network node comprises one of a protocol data unit (PDU) session anchor (PSA) user plane function (UPF), an intermediate UPF, or a network function.

5. The network node of claim 1, wherein the processor being configured to identify the PDU set information comprises the processor being configured to identify the PDU set information from MOQ metadata of the MOQ PDU, the MOQ metadata being extracted from the MOQ PDU by the network node acting as the MOQ relay.

6. The network node of claim 1, wherein including the PDU set information in the GTP-U header comprises marking the PDU with the PDU set information to enable the RAN node to apply PDU set based handling.

7. The network node of claim 1, wherein the processor being configured to establish the MOQ connection comprises the processor being configured to forward, to the application server and as a forwarding proxy, a connection request received from the WTRU.

8. The network node of claim 1, wherein the network node comprises a user plane function (UPF).

9. A method for a network node, the method comprising:
receiving, from a session management function (SMF), an N4 session request comprising an instruction to use a media over quick user datagram protocol internet connections (MOQ) relay functionality;
determining a MOQ relay instance and sending MOQ relay information associated with the MOQ relay instance to the SMF;
receiving a MOQ session establishment message from a wireless transmit/receive unit (WTRU) and establishing, as a MOQ relay, a MOQ connection with the WTRU and an application server;
receiving, from the application server, a MOQ protocol data unit (PDU) comprising PDU set information;
identifying the PDU set information associated with the MOQ PDU; and
transmitting a PDU to a radio access network (RAN) node, wherein the PDU set information is included in a GTP-U header of the PDU.

10. The method of claim 9, wherein the instruction to use the MOQ relay functionality comprises at least one of a MOQ service flag or a MOQ relay configuration information element.

11. The method of claim 9, wherein the MOQ relay information comprises at least one of a MOQ relay IP address, a fully qualified domain name (FQDN), or a port.

12. The method of claim 9, wherein the MOQ relay instance is collocated with the network node, and wherein the network node comprises one of a protocol data unit (PDU) session anchor (PSA) user plane function (UPF), an intermediate UPF, or a network function.

13. The method of claim 9, wherein identifying the PDU set information comprises identifying the PDU set information from MOQ metadata of the MOQ PDU, the MOQ metadata being extracted from the MOQ PDU by the network node acting as the MOQ relay.

14. The method of claim 9, wherein including the PDU set information in the GTP-U header comprises marking the PDU with the PDU set information to enable the RAN node to apply PDU set based handling.

15. The method of claim 9, wherein establishing the MOQ connection comprises forwarding, to the application server and as a forwarding proxy, a connection request received from the WTRU.

16. The method of claim 9, wherein the network node comprises a user plane function (UPF).
